(19) United States
(12) Patent Application Publication
(10) Pub. No.: US 2026/0142086 A1
(43) Pub. Date: May 21, 2026

(54) MULTILAYER CERAMIC CAPACITOR

(71) Applicant: Murata Manufacturing Co., Ltd., Nagaokakyo-shi (JP)

(72) Inventors: Jun KURITANI, Nagaokakyo-shi (JP); Yukie WATANABE, Nagaokakyo-shi (JP)

(21) Appl. No.: 19/446,054

(22) Filed: Jan. 12, 2026

Related U.S. Application Data
(63) Continuation of application No. PCT/JP2024/031808, filed on Sep. 5, 2024.

(51) Int. Cl. H01G 4/232; H01G 2/02; H01G 4/12; H01G 4/248; H01G 4/30

(52) U.S. Cl. CPC H01G 4/2325; H01G 2/02; H01G 4/248; H01G 4/30; H01G 4/12

(57) ABSTRACT

A multilayer ceramic capacitor includes a multilayer body including first to sixth surfaces, a first outer electrode on the first surface and the third surface, a second outer electrode on the first surface and the fourth surface, a third outer electrode on the first surface and the third surface, and a fourth outer electrode on the first surface and the fourth surface. The multilayer body includes first and second outer electrodes. The first outer electrode includes a first base layer connected to the first inner electrode, a first thin film layer on the first surface, a first upper plating layer, and a first recess located on an inner side of the multilayer body and having a dimension in a second direction longer than a dimension in a first direction.

### CROSS REFERENCE TO RELATED APPLICATIONS

This application is a Continuation Application of PCT Application No. PCT/JP2024/031808 filed on Sep. 5, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

In recent years, electronic devices such as mobile phones or portable music players have been reduced in size or thickness. With this reduction, multilayer ceramic capacitors to be mounted in the electronic devices reduced in size or thickness have also been reduced in size or thickness (refer to Japanese Unexamined Patent Application Publication No. 2021-101449). For example, some multilayer ceramic capacitors that have been particularly reduced in thickness are embedded in a circuit board, or regardless of when being mounted on the surface of the circuit board, multilayer ceramic capacitors are mounted in an extremely narrow gap.

### SUMMARY OF THE INVENTION

A multilayer ceramic capacitor described in, for example, Japanese Unexamined Patent Application Publication No. 2021-101449 has a profile with a substantially tetragonal shape, and has a reduced thickness in a lamination direction. When the thickness in the lamination direction is reduced, solder used for mounting extremely wets up in a direction perpendicular to the mounting surface, and rises up to the surface opposite to the mounting surface of the multilayer ceramic capacitor. Thus, the mount height may be increased by the wetting of the solder.

Example embodiments of the present invention provide multilayer ceramic capacitors that each reduce solder wetting up to a surface opposite a mounting surface during mounting.

A multilayer ceramic capacitor according to an example embodiment of the present invention includes a multilayer body including a first surface and a second surface opposite in a lamination direction, a third surface and a fourth surface opposite in a first perpendicular or substantially perpendicular to the lamination direction, and a fifth surface and a sixth surface opposite in a second perpendicular or substantially perpendicular to the lamination direction and the first direction, a first outer electrode on the first surface and the third surface, a second outer electrode on the first surface and the fourth surface, a third outer electrode on the first surface and the third surface, and a fourth outer electrode on the first surface and the fourth surface, wherein the multilayer body includes a first inner electrode, and a second inner electrode, the first outer electrode includes a first base layer connected to the first inner electrode, a first thin film layer on the first surface, and a first upper plating layer, the first outer electrode includes a first recess located on an inner side of the multilayer body, and the first recess has a dimension in the second direction longer than a dimension in the first direction.

In a multilayer ceramic capacitor according to an example embodiment of the present invention, the first outer electrode includes a first base layer connected to the first inner electrode, a first thin film layer on the first surface, and a first upper plating layer, and the first outer electrode includes a first recess located on an inner side of the multilayer body, and the first recess has a dimension in the second direction longer than a dimension in the first direction. Thus, during mounting, the first recess reduces solder wetting up from a first surface to an outer electrode on a surface adjacent to the first surface in the second direction.

Example embodiments of the present invention provide multilayer ceramic capacitors that each reduce solder wetting up to a surface opposite a mounting surface during mounting.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is an external perspective view of an example of a multilayer ceramic capacitor according to a first example embodiment of the present invention.

FIG. 1B is an external perspective view of the example of the multilayer ceramic capacitor according to the first example embodiment of the present invention, when viewed in another direction.

FIG. 2 is a front view of the example of the multilayer ceramic capacitor according to the first example embodiment of the present invention.

FIG. 3 is a side view of an example of the multilayer ceramic capacitor according to the first example embodiment of the present invention.

FIG. 4 is a schematic cross-sectional view taken along line IV-IV in FIG. 1A.

FIG. 5 is a schematic cross-sectional view taken along line V-V in FIG. 1A.

FIG. 6 is a schematic cross-sectional view taken along line VI-VI in FIG. 1A.

FIG. 7 is a schematic cross-sectional view taken along line VII-VII in FIG. 1A.

FIG. 8A is an enlarged view of a portion A in FIG. 6, schematically illustrating a structure of a base layer, and FIG. 8B is an enlarged view of a portion A in FIG. 6, and schematically illustrating a structure of Sn plating.

FIG. 9A is a schematic cross-sectional view taken along line IXA-IXA in FIG. 2.

FIG. 9B is a schematic cross-sectional view taken along line IXB-IXB in FIG. 2.

FIG. 10 is an exploded perspective view of the multilayer body illustrated in FIG. 1A.

FIG. 11A is an external perspective view of an example of a multilayer ceramic capacitor according to a second example embodiment of the present invention, when viewed in one direction.

FIG. 11B is an external perspective view of the example of the multilayer ceramic capacitor according to the second example embodiment of the present invention, when viewed in another direction.

FIG. 12 is a front view of an example of the multilayer ceramic capacitor according to the second example embodiment of the present invention.

FIG. 13 is a schematic cross-sectional view taken along line XIII-XIII in FIG. 11A.

FIG. 14 is a schematic cross-sectional view taken along line XIV-XIV in FIG. 11A.

FIG. 15 is a schematic cross-sectional view taken along line XV-XV in FIG. 11A.

FIG. 16 is a schematic cross-sectional view taken along line XVI-XVI in FIG. 11A.

FIG. 17A is a schematic cross-sectional view taken along line XVIIA-XVIIA in FIG. 12.

FIG. 17B is a schematic cross-sectional view taken along line XVIIB-XVIIB in FIG. 12.

FIG. 18 is an exploded perspective view of a multilayer body illustrated in FIG. 11A.

FIG. 19A is an external perspective view of an example of a multilayer ceramic capacitor according to a third example embodiment of the present invention.

FIG. 19B is an external perspective view of the example of the multilayer ceramic capacitor according to the third example embodiment of the present invention, when viewed in another direction.

FIG. 20 is a schematic cross-sectional view taken along line XX-XX in FIG. 19A.

FIG. 21 is a schematic cross-sectional view taken along line XXI-XXI in FIG. 19A.

FIG. 22 is a schematic cross-sectional view taken along line XXII-XXII in FIG. 19A.

FIG. 23 is a schematic cross-sectional view taken along line XXIII-XXIII in FIG. 19A.

### DETAILED DESCRIPTION OF THE EXAMPLE EMBODIMENTS

Example embodiments of multilayer ceramic capacitors according to example embodiments of the present invention are described now.

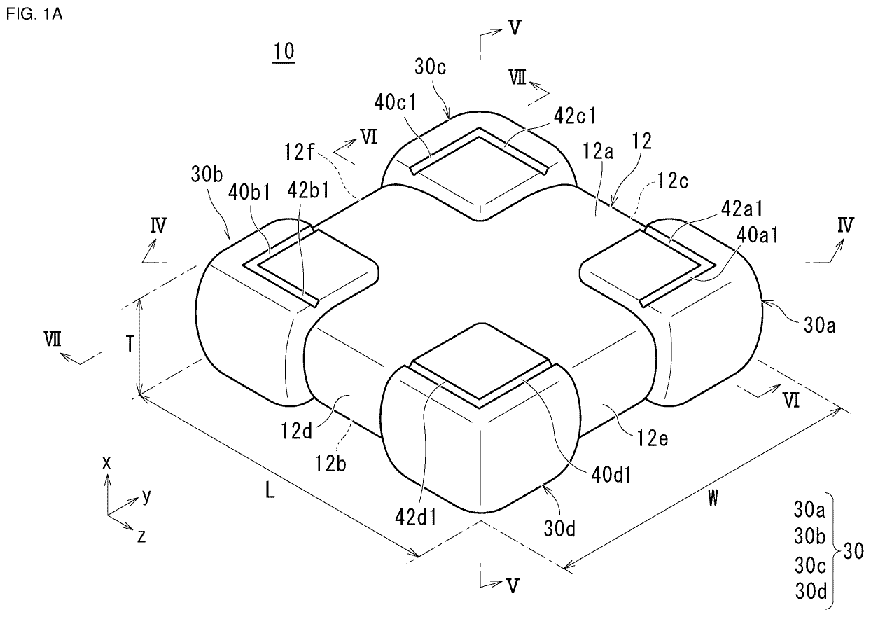

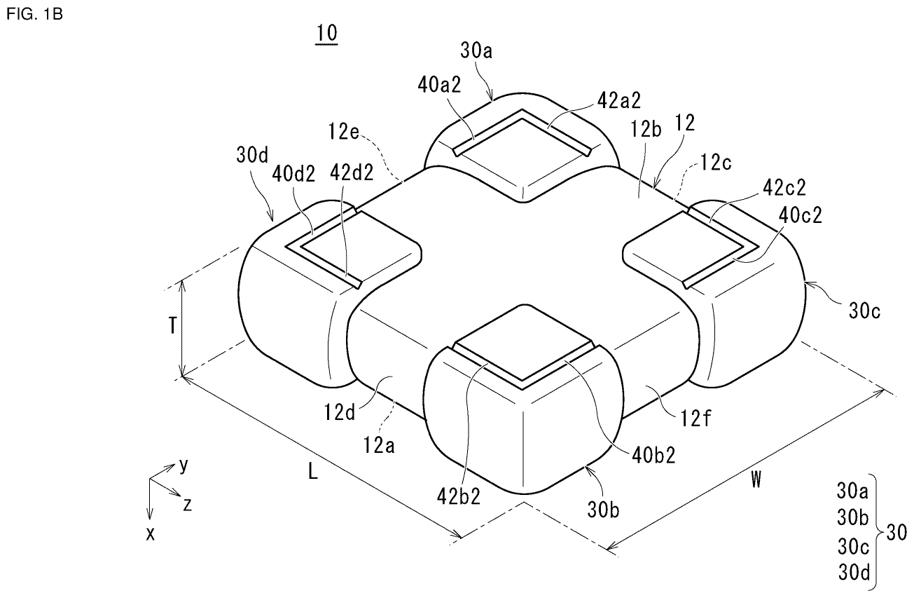

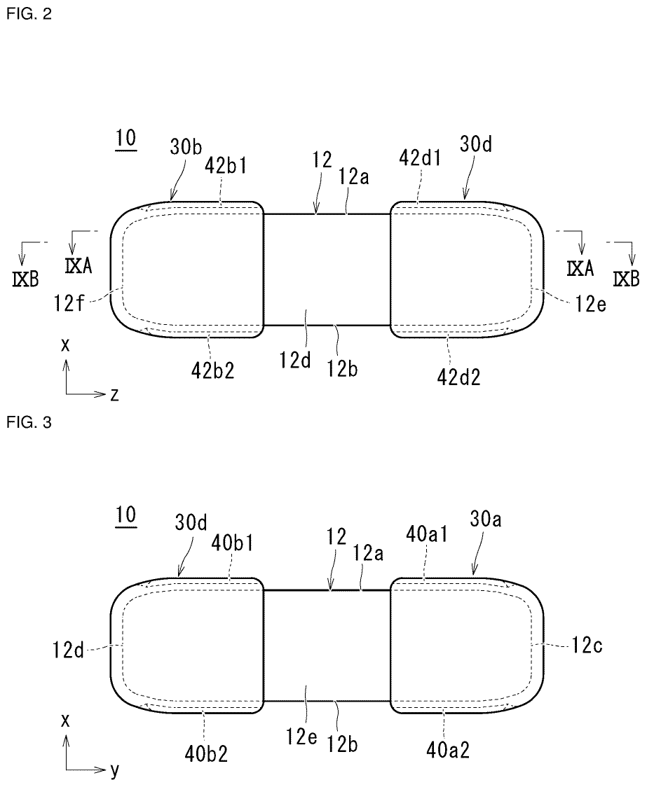

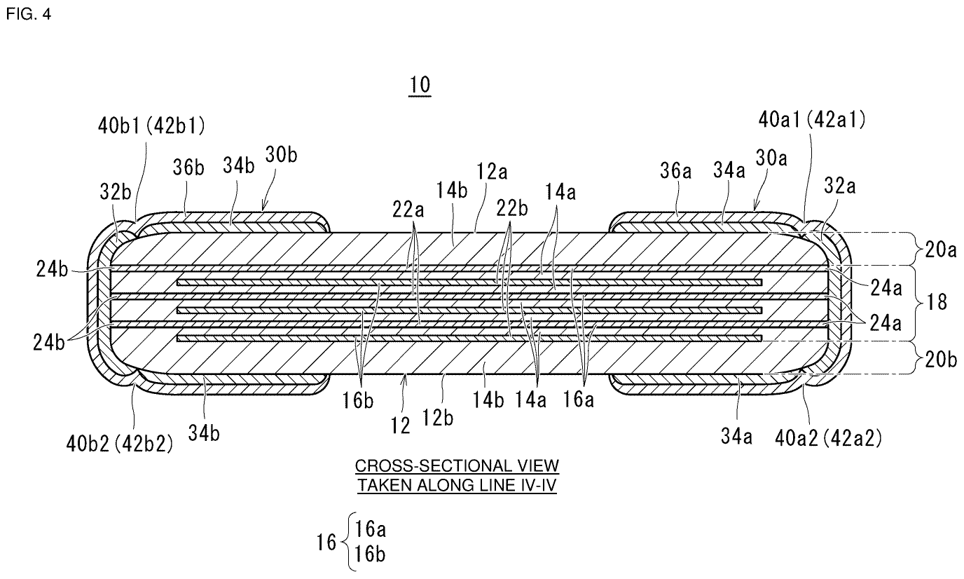

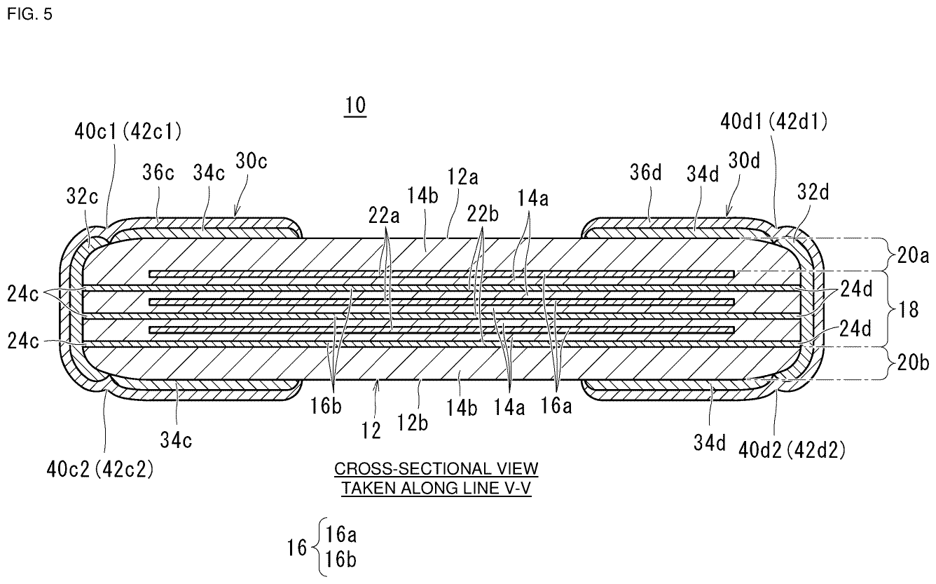

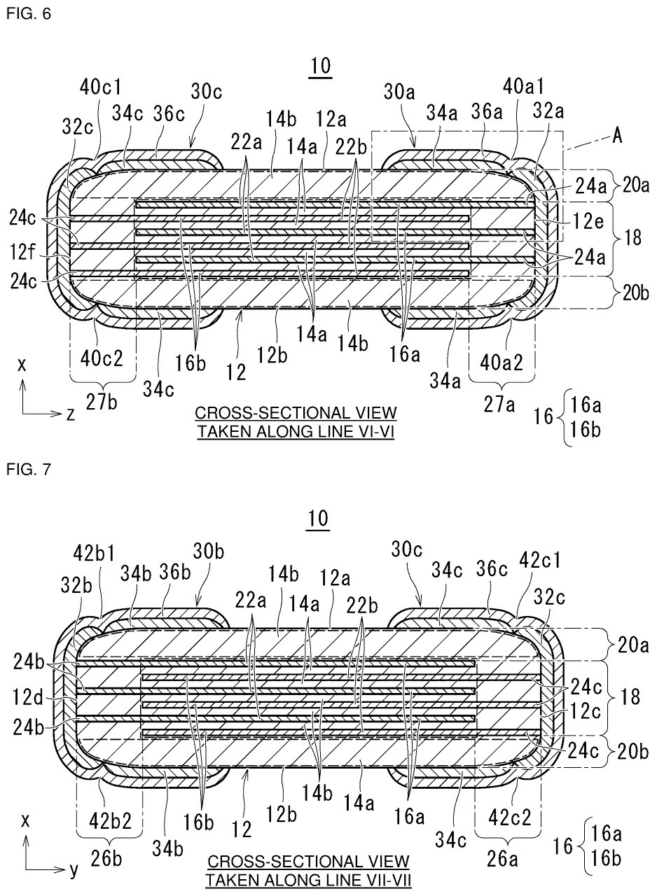

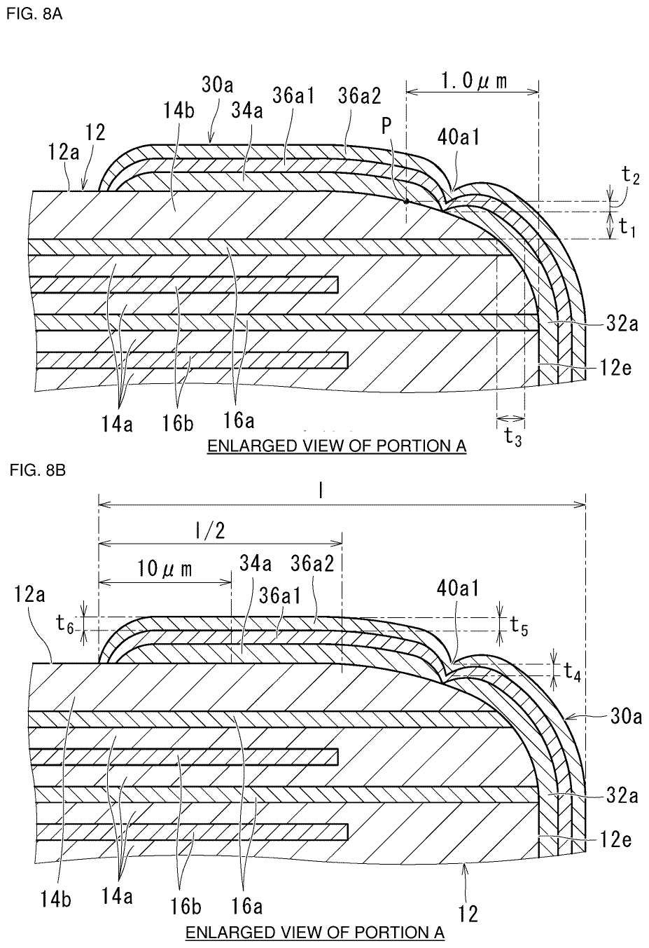

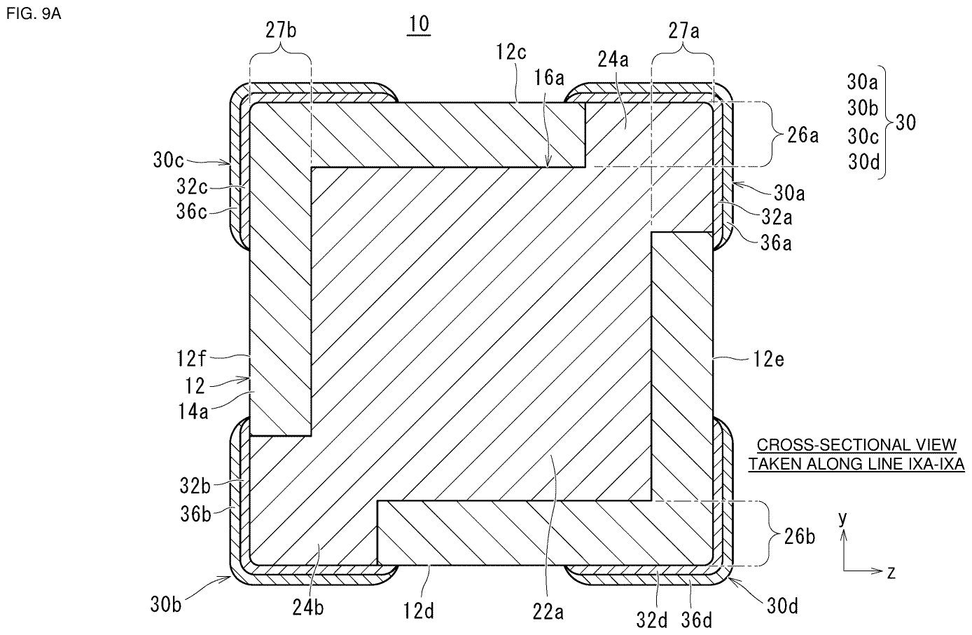

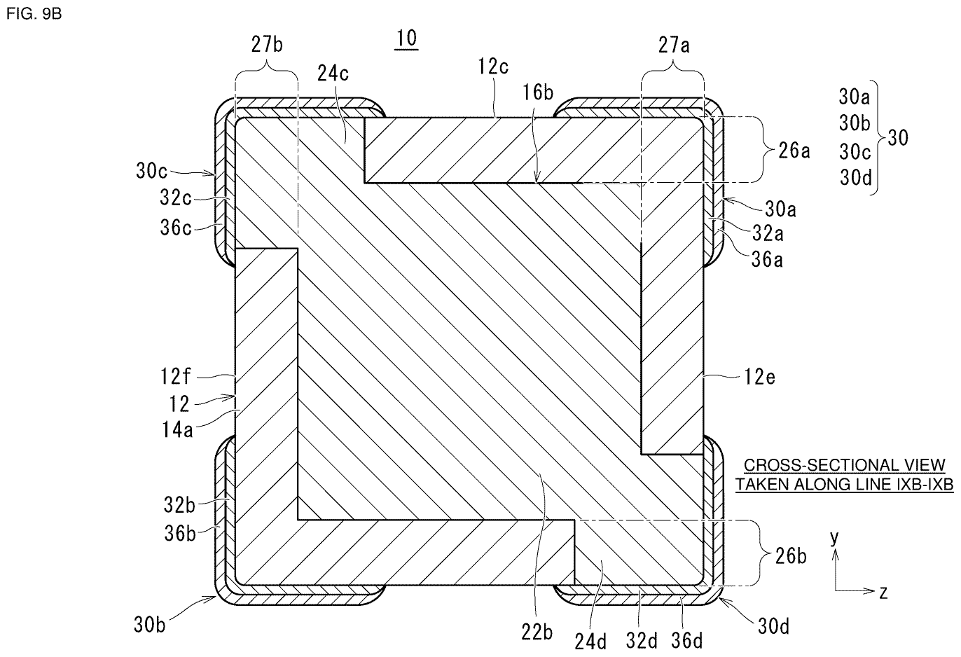

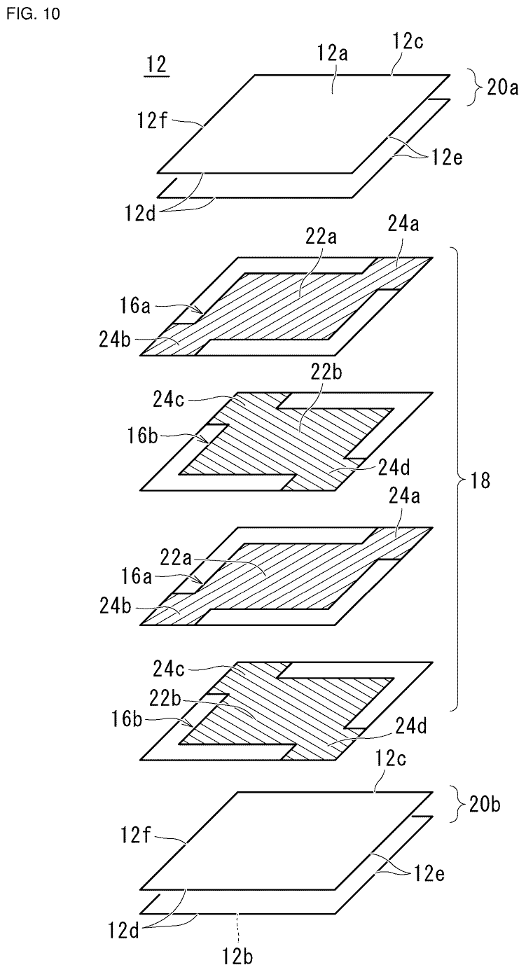

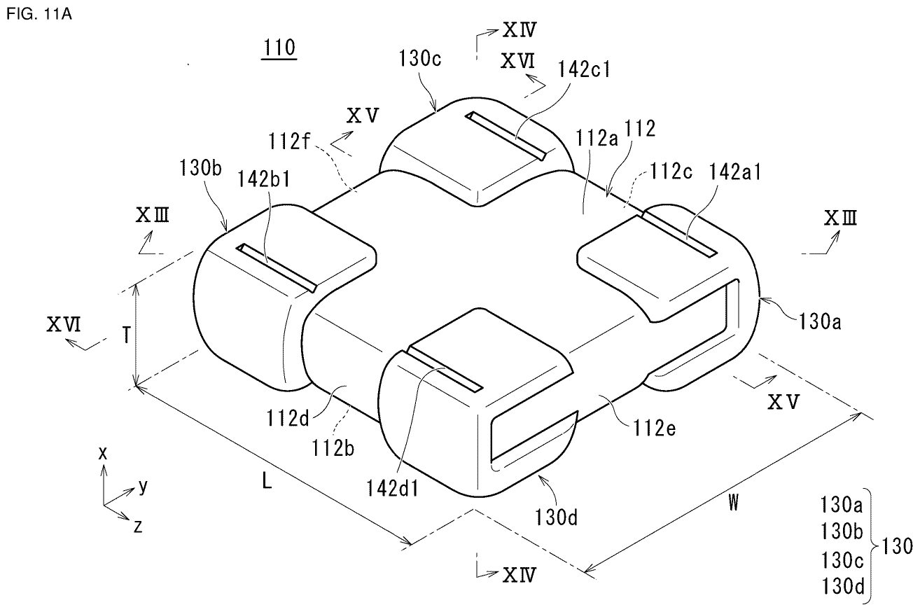

FIG. 1A is an external perspective view of an example of a multilayer ceramic capacitor according to a first example embodiment of the present invention. FIG. 1B is an external perspective view of the example of the multilayer ceramic capacitor according to the first example embodiment of the present invention, when viewed in another direction. FIG. 2 is a front view of the example of the multilayer ceramic capacitor according to the first example embodiment of the present invention. FIG. 3 is a side view of an example of the multilayer ceramic capacitor according to the first example embodiment of the present invention. FIG. 4 is a schematic cross-sectional view taken along line IV-IV in FIG. 1A. FIG. 5 is a schematic cross-sectional view taken along line V-V in FIG. 1A. FIG. 6 is a schematic cross-sectional view taken along line VI-VI in FIG. 1A. FIG. 7 is a schematic cross-sectional view taken along line VII-VII in FIG. 1A. FIG. 8A is an enlarged view of a portion A in FIG. 6, schematically illustrating a structure of a base layer, and FIG. 8B is an enlarged view of a portion A in FIG. 6, and schematically illustrating a structure of Sn plating. FIG. 9A is a schematic cross-sectional view taken along line IXA-IXA in FIG. 2. FIG. 9B is a schematic cross-sectional view taken along line IXB-IXB in FIG. 2. FIG. 10 is an exploded perspective view of the multilayer body illustrated in FIG. 1A.

The multilayer ceramic capacitor 10 includes a multilayer body 12 and multiple outer electrodes 30.

The multilayer body 12 includes a first surface 12a and a second surface 12b opposing in a lamination direction x, a third surface 12c and a fourth surface 12d opposing in a first direction y orthogonal to the lamination direction x, and a fifth surface 12e and a sixth surface 12f opposing in a second direction z orthogonal to the lamination direction x and the first direction y. The direction in which the first surface 12a and the second surface 12b of the multilayer body 12 are connected is the lamination direction x.

The multilayer body 12 preferably includes rounded corner portions and rounded ridgeline portions. Each corner portion is a portion where three adjacent surfaces of the multilayer body 12 cross. Each ridgeline portion is a portion where two adjacent surfaces of the multilayer body 12 cross. For example, protrusions and/or recesses may be provided over a portion of or an entirety of the third surface 12c, the fourth surface 12d, the fifth surface 12e, and the sixth surface 12f.

Either the first surface 12a or the second surface 12b may be roughened.

The multilayer body 12 includes multiple dielectric layers 14 and multiple inner electrodes 16. The dielectric layers 14 include inner dielectric layers 14a and outer dielectric layers 14b. The inner electrodes 16 include first inner electrodes 16a and second inner electrodes 16b.

The multilayer body 12 includes an inner layer portion 18, a first outer layer portion 20a located closer to the first surface 12a, and a second outer layer portion 20b located closer to the second surface 12b.

The first outer layer portion 20a is located closer to the first surface 12a of the multilayer body 12, and is a set of multiple outer dielectric layers 14b located between the first surface 12a and the inner electrode 16 located closest to the first surface 12a.

The second outer layer portion 20b is located closer to the second surface 12b of the multilayer body 12, and is a set of multiple outer dielectric layers 14b located between the second surface 12b and the inner electrode 16 located closest to the second surface 12b.

The area between the first outer layer portion 20a and the second outer layer portion 20b is the inner layer portion 18.

The inner layer portion 18 includes first inner electrodes 16a each including a first end exposed to the third surface 12c and the fifth surface 12e and a second end exposed to the fourth surface 12d and the sixth surface 12f, second inner electrodes 16b each including a first end exposed to the third surface 12c and the sixth surface 12f and a second end exposed to the fourth surface 12d and the fifth surface 12e, and inner dielectric layers 14a.

The dielectric layers 14 may include, for example, a dielectric material. Examples of the dielectric material include a dielectric ceramic mainly including a component such as BaTiO₃, CaTiO₃, SrTiO₃, or CaZrO₃. Alternatively, a dielectric material obtained by adding a secondary component such as an Mn compound, an Fe compound, a Cr compound, a Co compound, or an Ni compound to any of these main components may be used. The inner dielectric layers 14a and the outer dielectric layers 14b may include the same dielectric material. The inner layer portion 18 and the outer layer portions 20a and 20b may include different dielectric materials to be used for different functions. At least one of materials such as Si, Mg, Ba, or Mn may be added as an additive.

When the inner dielectric layers 14a include, for example, a large amount of CaTiO₃ or CaZrO₃ as a dielectric component, the inner dielectric layers 14a can reduce occurrence of dielectric breakdown between the first inner electrodes 16a and the second inner electrodes 16b. Alternatively, the inner dielectric layers 14a may include, for example, SrTiO₃ as a main component. Still alternatively, the inner dielectric layers 14a preferably include a material with high permittivity, such as BaTiO₃, to increase the capacitance of the multilayer ceramic capacitor 10. Preferably, the components of the outer dielectric layers 14b are the same as the components of the inner dielectric layers 14a.

The dielectric layers 14 may include multiple crystal grains including a perovskite compound including BaTiO₃ as a basic structure.

The dielectric layers 14 having a smaller thickness have larger capacitance as a capacitor, and the crystal grain size is thus preferably smaller than or equal to about 1 μm, for example. Although not limited to a particular one, the number of laminated dielectric layers 14 is preferably greater than or equal to three and less than or equal to three hundred, including the number of the first outer layer portion 20a and the second outer layer portion 20b. Preferably, the thickness of the inner dielectric layers 14a is, for example, greater than or equal to about 0.4 μm and less than or equal to about 2.0 μm, and the thickness of the outer dielectric layers 14b is, for example, greater than or equal to about 2.0 μm and less than or equal to about 100.0 μm.

When the direction in which the third surface 12c and the fourth surface 12d face each other is defined as a first direction y, and the direction in which the fifth surface 12e and the sixth surface 12f face each other is defined as a second direction z, a dimension [symbol] W of the multilayer body 12 in the first direction y and a dimension [symbol] L of the multilayer body 12 in the second direction z satisfy the condition of about 0.85≤L/W≤about 1.00, for example. More specifically, the multilayer body 12 has a substantially tetragonal shape.

The inner electrodes 16 include multiple first inner electrodes 16a and multiple second inner electrodes 16b. The first inner electrodes 16a and the second inner electrodes 16b are alternately laminated with the dielectric layers 14 interposed therebetween.

The first inner electrodes 16a are disposed on the surfaces of the inner dielectric layers 14a. The first inner electrodes 16a each face the first surface 12a and the second surface 12b, each include a first opposite electrode portion 22a that faces the second inner electrodes 16b, and are laminated in a direction in which the first surface 12a and the second surface 12b are connected.

The first inner electrodes 16a are drawn out to the third surface 12c and the fifth surface 12e of the multilayer body 12 with first extended electrode portions 24a, and drawn out to the fourth surface 12d and the sixth surface 12f of the multilayer body 12 with second extended electrode portions 24b. The width of the first extended electrode portions 24a by which the first extended electrode portions 24a are drawn out to the third surface 12c may be the same as the width of the first extended electrode portions 24a by which the first extended electrode portions 24a are drawn out to the fifth surface 12e, and the width of the second extended electrode portions 24b by which the second extended electrode portions 24b are drawn out to the fourth surface 12d may be the same as the width of the second extended electrode portions 24b by which the second extended electrode portions 24b are drawn out to the sixth surface 12f.

The first inner electrodes 16a are drawn out with the first extended electrode portions 24a continuously between the third surface 12c and the fifth surface 12e of the multilayer body 12, and drawn out with the second extended electrode portions 24b continuously between the fourth surface 12d and the sixth surface 12f of the multilayer body 12. Alternatively, the first inner electrodes 16a may be drawn out discontinuously.

The second inner electrodes 16b are disposed on the surfaces of the inner dielectric layers 14a different from the inner dielectric layers 14a on which the first inner electrodes 16a are disposed. The second inner electrodes 16b each face the first surface 12a and the second surface 12b, each include a second opposite electrode portion 22b that faces the first inner electrodes 16a, and are laminated in a direction in which the first surface 12a and the second surface 12b are connected.

The second inner electrodes 16b are drawn out to the third surface 12c and the sixth surface 12f of the multilayer body 12 with third extended electrode portions 24c, and drawn out to the fourth surface 12d and the fifth surface 12e of the multilayer body 12 with fourth extended electrode portions 24d. The width of the third extended electrode portions 24c by which the third extended electrode portions 24c are drawn out to the third surface 12c may be the same as the width of the third extended electrode portions 24c by which the third extended electrode portions 24c are drawn out to the sixth surface 12f, and the width of the fourth extended electrode portions 24d by which the fourth extended electrode portions 24d are drawn out to the fourth surface 12d may be the same as the width of the fourth extended electrode portions 24d by which the fourth extended electrode portions 24d are drawn out to the fifth surface 12e.

The second inner electrodes 16b are drawn out with the third extended electrode portions 24c continuously between the third surface 12c and the sixth surface 12f of the multilayer body 12, and drawn out with the fourth extended electrode portions 24d continuously between the fourth surface 12d and the fifth surface 12e of the multilayer body 12. Alternatively, the second inner electrodes 16b may be drawn out discontinuously.

When the multilayer ceramic capacitor 10 is viewed in the lamination direction x, preferably, a straight line connecting the first extended electrode portion 24a and the second extended electrode portion 24b of each first inner electrode 16a and a straight line connecting the third extended electrode portion 24c and the fourth extended electrode portion 24d of each second inner electrode 16b cross each other.

As illustrated in FIG. 7, the multilayer body 12 includes a side portion (W gap) 26a of the multilayer body 12 located between the third surface 12c and first ends of the first opposite electrode portions 22a of the first inner electrodes 16a in the first direction y, and a side portion (W gap) 26b of the multilayer body 12 located between the fourth surface 12d and second ends of the second opposite electrode portions 22b of the second inner electrodes 16b in the first direction y.

As illustrated in FIG. 6, the multilayer body 12 further includes an end portion (L gap) 27a of the multilayer body 12 located between the fifth surface 12e and first ends of the second opposite electrode portions 22b of the second inner electrodes 16b in the second direction z, and an end portion (L gap) 27b of the multilayer body 12 located between the sixth surface 12f and second ends of the first opposite electrode portions 22a of the first inner electrodes 16a in the second direction z.

The first inner electrodes 16a and the second inner electrodes 16b may include an appropriate electroconductive material, for example, a metal such as Ni, Cu, Ag, Pd, or Au, or an alloy including at least one of these metals such as an Ni—Cu alloy or an Ag—Pd alloy, but the first inner electrodes 16a and the second inner electrodes 16b may include another material. The first inner electrodes 16a and the second inner electrodes 16b may include the same electroconductive material or different electroconductive materials.

When an Sn layer is disposed at the interface between each of the first inner electrodes 16a and the second inner electrodes 16b and the corresponding dielectric layer 14, electric field concentration at the interface between each inner electrode 16 and the corresponding dielectric layer 14 can be reduced, and high-temperature load reliability is improved.

The number of the first inner electrodes 16a and the second inner electrodes 16b in total is preferably greater than or equal to three and less than or equal to three hundred. Although not limited to a particular one, the thickness of the first inner electrodes 16a and the second inner electrodes 16b is, for example, greater than or equal to about 0.2 μm and less than or equal to about 2.0 μm.

The multilayer body 12 of the multilayer ceramic capacitor 10 may have a structure described below.

In the multilayer ceramic capacitor 10, the third surface 12c to the sixth surface 12f of the multilayer body 12 may be curved outward from the center of the multilayer body 12, when viewed in the lamination direction x. More specifically, the third surface 12c to the sixth surface 12f of the multilayer body 12 may be warped. In this structure, preferably, each of the third surface 12c to the sixth surface 12f is curved or warped about its center. In this structure, the distance between the outer electrodes 30 adjacent to each other, described below, can be increased, and thus, the possibility of electric conduction between the outer electrodes 30 can be reduced.

When viewed in at least one of the first direction y and the second direction z, areas of the third surface 12c to the sixth surface 12f to which the inner electrodes 16 are drawn out are preferably rounded to extend from the first surface 12a to the second surface 12b. In this structure, the exposure area of the inner electrodes 16 is increased, and thus, the area over which the inner electrodes 16 and the outer electrodes 30 are in contact with one another can be increased.

As illustrated in FIG. 1 to FIG. 7, the outer electrodes 30 are disposed at the multilayer body 12.

The outer electrodes 30 include multiple outer electrodes 30 connected to the first inner electrodes 16a and the second inner electrodes 16b. The outer electrodes 30 include a first outer electrode 30a, a second outer electrode 30b, a third outer electrode 30c, and a fourth outer electrode 30d. The first outer electrode 30a covers the first extended electrode portions 24a of the first inner electrodes 16a on the third surface 12c and the fifth surface 12e, and the first outer electrode 30a also covers a portion of the first surface 12a and a portion of the second surface 12b. The first outer electrode 30a is electrically connected to the first extended electrode portions 24a of the first inner electrodes 16a.

The second outer electrode 30b covers the second extended electrode portions 24b of the first inner electrodes 16a on the fourth surface 12d and the sixth surface 12f, and the second outer electrode 30b also covers a portion of the first surface 12a and a portion of the second surface 12b. The second outer electrode 30b is electrically connected to the second extended electrode portions 24b of the first inner electrodes 16a.

The third outer electrode 30c covers the third extended electrode portions 24c of the second inner electrodes 16b on the third surface 12c and the sixth surface 12f, and the third outer electrode 30c also covers a portion of the first surface 12a and a portion of the second surface 12b. The third outer electrode 30c is electrically connected to the third extended electrode portions 24c of the second inner electrodes 16b.

The fourth outer electrode 30d covers the fourth extended electrode portions 24d of the second inner electrodes 16b on the fourth surface 12d and the fifth surface 12e, and the fourth outer electrode 30d also covers a portion of the first surface 12a and a portion of the second surface 12b. The fourth outer electrode 30d is electrically connected to the fourth extended electrode portions 24d of the second inner electrodes 16b.

When viewed in the lamination direction x, each outer electrode 30 includes a first recess 40 extending in the first direction y on the inner side of the multilayer body 12. Each outer electrode 30 may include a second recess 42 extending in the second direction z on the inner side of the multilayer body 12.

More specifically, when the first outer electrode 30a covers the first surface 12a, the second surface 12b, the third surface 12c, and the fifth surface 12e, when viewed in the lamination direction x from the first surface 12a, the first outer electrode 30a has a second recess 42al extending in the second direction z, at a portion closer to the third surface 12c, and a first recess 40al extending in the first direction y, at a portion closer to the fifth surface 12e.

When the first outer electrode 30a covers the first surface 12a, the second surface 12b, the third surface 12c, and the fifth surface 12e, when viewed in the lamination direction x from the second surface 12b, the first outer electrode 30a has a second recess 42a2 extending in the second direction z, at a portion closer to the third surface 12c, and a first recess 40a2 extending in the first direction y, at a portion closer to the fifth surface 12e.

When viewed in the lamination direction x from the first surface 12a, the dimension of the first recess 40al in the first direction y is, for example, greater than or equal to about 10% and less than or equal to about 96.0% of the dimension of the first outer electrode 30a in the first direction y on which the first recess 40a1 is formed. More preferably, the dimension of the first recess 40a1 in the first direction y is, for example, less than or equal to about 100% of the dimension of the first outer electrode 30a in the first direction y. Similarly, when viewed in the lamination direction x from the second surface 12b, the dimension of the first recess 40a2 in the first direction y is, for example, greater than or equal to about 10% and less than or equal to about 96.0% of the dimension of the first outer electrode 30a in the first direction y on which the first recess 40a2 is formed. More preferably, the dimension of the first recess 40a2 in the first direction y is, for example, less than or equal to about 100% of the dimension of the first outer electrode 30a in the first direction y. This structure can reduce solder excessively wetting up to the fifth surface 12e. When each of the first recess 40al and the first recess 40a2 is discontinuously formed, the dimension of the first recess 40al or the first recess 40a2 in the first direction y is defined by the total length of the first recess 40al or the first recess 40a2.

Preferably, the first recess 40al is located within a range that is, for example, greater than or equal to about 0.01 μm and less than or equal to about 10.0 μm from the outermost surface of the fifth surface 12e of the multilayer body 12. Similarly, preferably, the first recess 40a2 is located within a range that is, for example, greater than or equal to about 0.01 μm and less than or equal to about 10.0 μm from the outermost surface of the fifth surface 12e of the multilayer body 12. More specifically, the first recess 40al and the first recess 40a2 are located on the inner side of the multilayer body 12. This structure can block, using the first recess 40al, or trap, in the first recess 40al, solder wetting up from the first surface 12a to the outer electrode 30 on the surface adjacent to the first surface 12a in the second direction z, and thus can reduce solder wetting up to the fifth surface 12e.

The first recess 40al and the second recess 42al may be connected to each other. The first recess 40al and the second recess 42a1 connected to each other can also reduce solder wetting up to a portion where adjacent two surfaces cross. Similarly, the first recess 40a2 and the second recess 42a2 may be connected to each other. The first recess 40a2 and the second recess 42a2 connected to each other can also reduce solder wetting up to a portion where adjacent two surfaces cross. When viewed in the first direction y, the distance from the bottom surface of the first recess 40al to the top of an upper plating layer 36, described later, located outward from the first recess 40al is preferably greater than or equal to 1.0 μm.

When the second outer electrode 30b covers the first surface 12a, the second surface 12b, the fourth surface 12d, and the sixth surface 12f, when viewed in the lamination direction x from the first surface 12a, the second outer electrode 30b has a second recess 42b1 extending in the second direction z at a portion closer to the fourth surface 12d, and a first recess 40b1 extending in the first direction y at a portion closer to the sixth surface 12f.

When the second outer electrode 30b covers the first surface 12a, the second surface 12b, the fourth surface 12d, and the sixth surface 12f, when viewed in the lamination direction x from the second surface 12b, the second outer electrode 30b has a second recess 42b2 extending in the second direction z at a portion closer to the fourth surface 12d, and a first recess 40b2 extending in the first direction y at a portion closer to the sixth surface 12f.

The second outer electrode 30b has the same structure as the first outer electrode 30a at other portions.

When the third outer electrode 30c covers the first surface 12a, the second surface 12b, the third surface 12c, and the sixth surface 12f, when viewed in the lamination direction x from the first surface 12a, the third outer electrode 30c has a second recess 42cl extending in the second direction z at a portion closer to the third surface 12c, and a first recess 40cl extending in the first direction y at a portion closer to the sixth surface 12f.

When the third outer electrode 30c covers the first surface 12a, the second surface 12b, the third surface 12c, and the sixth surface 12f, when viewed in the lamination direction x from the second surface 12b, the third outer electrode 30c has a second recess 42c2 extending in the second direction z at a portion closer to the third surface 12c, and a first recess 40c2 extending in the first direction y at a portion closer to the sixth surface 12f.

The third outer electrode 30c has the same structure as the first outer electrode 30a at other portions.

When the fourth outer electrode 30d covers the first surface 12a, the second surface 12b, the fourth surface 12d, and the fifth surface 12e, when viewed in the lamination direction x from the first surface 12a, the fourth outer electrode 30d has a second recess 42d1 extending in the second direction z at a portion closer to the fourth surface 12d, and a first recess 40d1 extending in the first direction y at a portion closer to the fifth surface 12e.

When the fourth outer electrode 30d covers the first surface 12a, the second surface 12b, the fourth surface 12d, and the fifth surface 12e, when viewed in the lamination direction x from the second surface 12b, the fourth outer electrode 30d has a second recess 42d2 extending in the second direction z at a portion closer to the fourth surface 12d, and a first recess 40d2 extending in the first direction y at a portion closer to the fifth surface 12e.

The fourth outer electrode 30d has the same structure as the first outer electrode 30a at other portions.

In the multilayer body 12, the first opposite electrode portion 22a of each first inner electrode 16a faces the second opposite electrode portion 22b of the corresponding second inner electrode 16b with the corresponding inner dielectric layer 14a interposed therebetween to generate electrostatic capacitance. Thus, an electrostatic capacitance can be obtained between the first outer electrode 30a and the second outer electrode 30b to which the first inner electrodes 16a are connected, and between the third outer electrode 30c and the fourth outer electrode 30d to which the second inner electrodes 16b are connected, and characteristics of a capacitor thus appear.

The first outer electrode 30a, the second outer electrode 30b, the third outer electrode 30c, and the fourth outer electrode 30d each include a base layer 32, thin film layers 34, and an upper plating layer 36.

In other words, the first outer electrode 30a includes a first base layer 32a, first thin film layers 34a, and a first upper plating layer 36a. The second outer electrode 30b includes a second base layer 32b, second thin film layers 34b, and a second upper plating layer 36b. The third outer electrode 30c includes a third base layer 32c, third thin film layers 34c, and a third upper plating layer 36c. The fourth outer electrode 30d includes a fourth base layer 32d, fourth thin film layers 34d, and a fourth upper plating layer 36d.

The base layers 32 are disposed on the third surface 12c to the sixth surface 12f. Hereafter, a specific structure of the base layers 32 is described.

The first base layer 32a is disposed on the third surface 12c and the fifth surface 12e of the multilayer body 12 to cover the first extended electrode portions 24a of the first inner electrodes 16a exposed from the third surface 12c and the fifth surface 12e of the multilayer body 12.

The second base layer 32b is disposed on the fourth surface 12d and the sixth surface 12f of the multilayer body 12 to cover the second extended electrode portions 24b of the first inner electrodes 16a exposed from the fourth surface 12d and the sixth surface 12f of the multilayer body 12.

The third base layer 32c is disposed on the third surface 12c and the sixth surface 12f of the multilayer body 12 to cover the third extended electrode portions 24c of the second inner electrodes 16b exposed from the third surface 12c and the sixth surface 12f of the multilayer body 12.

The fourth base layer 32d is disposed on the fourth surface 12d and the fifth surface 12e of the multilayer body 12 to cover the fourth extended electrode portions 24d of the second inner electrodes 16b exposed from the fourth surface 12d and the fifth surface 12e of the multilayer body 12.

Preferably, the upper end of the first base layer 32a of the first outer electrode 30a is connected to the first thin film layer 34a on a ridgeline portion defined by the first surface 12a and each of the third surface 12c and the fifth surface 12e of the multilayer body 12. Preferably, the lower end of the first base layer 32a of the first outer electrode 30a is connected to the first thin film layer 34a on a ridgeline portion defined by the second surface 12b and each of the third surface 12c and the fifth surface 12e of the multilayer body 12. At this time, the first base layer 32a may cover a ridgeline portion defined by the third surface 12c and the fifth surface 12e.

With reference to FIG. 8A, the structure of the first base layer 32a of the first outer electrode 30a is described in detail as an example. As illustrated in FIG. 8A, preferably, a distance t1 in the lamination direction x between the end of the first base layer 32a in the lamination direction x on the fifth surface 12e and the end portion of the inner electrode 16 located closest to the first surface 12a and exposed to the fifth surface 12e is, for example, greater than or equal to about 3.0 μm and less than or equal to about 8.1 μm. Preferably, the first base layer 32a extends toward the first surface 12a. In other words, preferably, a distance t2 in the lamination direction x from a point P on the outermost surface of the first surface 12a located about 1.0 μm inward from the fifth surface 12e to the end of the first base layer 32a in the lamination direction x is less than or equal to about 10.0 μm, for example.

Preferably, a thickness t3 of the first base layer 32a in the first direction y from the end portion of the inner electrode 16 located closest to the first surface 12a and exposed to the fifth surface 12e is greater than or equal to about 3.0 μm and less than or equal to about 8.1 μm, for example.

Preferably, the upper end of the second base layer 32b of the second outer electrode 30b is connected to the second thin film layer 34b on a ridgeline portion defined by the first surface 12a and each of the fourth surface 12d and the sixth surface 12f of the multilayer body 12. Preferably, the lower end of the second base layer 32b of the second outer electrode 30b is connected to the second thin film layer 34b on a ridgeline portion defined by the second surface 12b and each of the fourth surface 12d and the sixth surface 12f of the multilayer body 12. At this time, the second base layer 32b may cover a ridgeline portion defined by the fourth surface 12d and the sixth surface 12f.

The second outer electrode 30b has the same structure as the first outer electrode 30a at other portions.

Preferably, the upper end of the third base layer 32c of the third outer electrode 30c is connected to the third thin film layer 34c on the ridgeline portion defined by the first surface 12a and each of the third surface 12c and the sixth surface 12f of the multilayer body 12. Preferably, the lower end of the third base layer 32c of the third outer electrode 30c is connected to the third thin film layer 34c on a ridgeline portion defined by the second surface 12b and each of the third surface 12c and the sixth surface 12f of the multilayer body 12. At this time, the third base layer 32c may cover a ridgeline portion defined by the third surface 12c and the sixth surface 12f.

The third outer electrode 30c has the same structure as the first outer electrode 30a at other portions.

Preferably, the upper end of the fourth base layer 32d of the fourth outer electrode 30d is connected to the fourth thin film layer 34d on a ridgeline portion defined by the first surface 12a and each of the fourth surface 12d and the fifth surface 12e of the multilayer body 12. Preferably, the lower end of the fourth base layer 32d of the fourth outer electrode 30d is connected to the fourth thin film layer 34d on a ridgeline portion defined by the second surface 12b and each of the fourth surface 12d and the fifth surface 12e of the multilayer body 12. At this time, the fourth base layer 32d may cover a ridgeline portion defined by the fourth surface 12d and the fifth surface 12e.

The fourth outer electrode 30d has the same structure as the first outer electrode 30a at other portions.

Each base layer 32 includes, for example, Cu as a main component of metal. When, for example, the first inner electrodes 16a and the second inner electrodes 16b include Ni, the base layer 32 is preferably formed from Cu plating compatibly coupled with Ni.

Each base layer 32 is formed from plating that grows from the inner electrodes 16.

Preferably, the thickness of each base layer 32 is greater than or equal to about 0.5 μm and less than or equal to about 10.0 μm, for example.

The thin film layers 34 include first thin film layers 34a, second thin film layers 34b, third thin film layers 34c, and fourth thin film layers 34d.

The first thin film layers 34a cover a portion of the first surface 12a and a portion of the second surface 12b of the multilayer body 12 located closer to the third surface 12c and the fifth surface 12e. Preferably, the first thin film layers 34a are connected to the first base layer 32a.

The second thin film layers 34b cover a portion of the first surface 12a and a portion of the second surface 12b of the multilayer body 12 located closer to the fourth surface 12d and the sixth surface 12f. Preferably, the second thin film layers 34b are connected to the second base layer 32b.

The third thin film layers 34c cover a portion of the first surface 12a and a portion of the second surface 12b of the multilayer body 12 located closer to the third surface 12c and the sixth surface 12f. Preferably, the third thin film layers 34c are connected to the third base layer 32c.

The fourth thin film layers 34d cover a portion of the first surface 12a and the second surface 12b of the multilayer body 12 located closer to the fourth surface 12d and the fifth surface 12e. Preferably, the fourth thin film layers 34d are connected to the fourth base layer 32d.

Preferably, each of the first thin film layers 34a to the fourth thin film layers 34d is formed from metal particles accumulated by sputtering or deposition. Thus, the thickness of the first thin film layers 34a to the fourth thin film layers 34d in a direction in which the first surface 12a and the second surface 12b of the multilayer body 12 are connected can be reduced to less than or equal to about 1 μm, for example, and the dimension of the multilayer ceramic capacitor 10 in the lamination direction x can be fully reduced. Thus, the height of the multilayer ceramic capacitor 10 can be reduced.

The dimension of the first thin film layers 34a to the fourth thin film layers 34d in the lamination direction x can be measured in the method described below. More specifically, when a thin film layer is defined by accumulation of metal particles, the thickness can be found by conversion based on the concentration of a predetermined chemical element using a calibration curve of the corresponding metal type with a fluorescent X-ray apparatus. Alternatively, the thickness can be measured from an actual image obtained by observing a cross section of a component, obtained using a focused ion beam (FIB), with a scanning electron microscope.

When the first thin film layers 34a to the fourth thin film layers 34d are formed by a method for forming thin films, these thin film layers are preferably formed from a metal such as Cu or Ni.

The first thin film layers 34a to the fourth thin film layers 34d can be formed in consideration of the respective functions. For example, in consideration of adhesion to the multilayer body 12, the first thin film layers 34a to the fourth thin film layers 34d may include NiCr or NiCu as a main component. Each of the first thin film layers 34a to the fourth thin film layers 34d may include multiple layers, and may have a two-layer structure including NiCr and NiCu.

The thin film layers 34 may include a dielectric material and a metal component defined by, for example, screen printing. In this structure, the ceramics in the thin film layers 34 and the multilayer body 12 adhere to each other, and the adhesion between the multilayer body 12 and the outer electrodes 30 can be improved. At this time, the thin film layers 34 may include, in addition to a metal component, a ceramic component that is the same as the main component of the inner dielectric layers 14a. When the thin film layers 34 include a ceramic component, the difference in coefficient of thermal expansion between the multilayer body 12 and the thin film layers 34 can be reduced, and the stress exerted on the thin film layers 34 can be reduced. However, instead of Cu or Ni, another metal component may be included as a metal component, or a glass component may be included in addition to the ceramic component. Examples of a glass component include an oxide of, for example, barium (Ba), strontium (Sr), silicon (Si), calcium (Ca), Zn, Al, or boron (B). Examples of other metal components include Mg, Cr, Sr, Al, Na, and Fe. The thin film layers 34 may have a discontinuous shape. The discontinuous shape here indicates that each thin film layer 34 is discontinuously provided when viewed in a perpendicular or substantially perpendicular to the longitudinal direction.

When, for example, the thin film layers 34 include a material including any ceramic, the thickness may be obtained by a method including conversion based on a cross-sectional photo taken after grinding a cross section and then obtained by, for example, using a digital microscope (VHX-5000 from Keyence Corporation). Alternatively, for example, the thickness may be measured by a method of actually observing, using a scanning electron microscope, an image of a cross section of a component obtained by FIB.

The upper plating layers 36 include a first upper plating layer 36a, a second upper plating layer 36b, a third upper plating layer 36c, and a fourth upper plating layer 36d.

The first upper plating layer 36a covers the first thin film layers 34a and the first base layer 32a disposed at the third surface 12c and the fifth surface 12e of the multilayer body 12.

The second upper plating layer 36b covers the second thin film layers 34b and the second base layer 32b disposed at the fourth surface 12d and the sixth surface 12f of the multilayer body 12.

The third upper plating layer 36c covers the third thin film layers 34c and the third base layer 32c disposed at the third surface 12c and the sixth surface 12f of the multilayer body 12.

The fourth upper plating layer 36d covers the fourth thin film layers 34d and the fourth base layer 32d disposed at the fourth surface 12d and the fifth surface 12e of the multilayer body 12.

Preferably, the upper plating layers 36 include at least one of metals selected from the group including, for example, Cu, Ni, Sn, Pb, Au, Ag, Pd, Bi, and Zn or an alloy including any of these metals. Preferably, plating layers do not include glass.

Each upper plating layer 36 may include, for example, only Sn plating, or may preferably have a two-layer structure including Ni plating and Sn plating, or Ni plating and Cu plating.

Sn plating covers Ni plating. More specifically, Sn plating is defined by growing from Ni plating as a starting point. Preferably, Sn plating has a thickness greater than or equal to about 1.0 μm and less than or equal to about 5.0 μm, for example. FIG. 8B illustrates the plating structure in detail using the first upper plating layer 36a of the first outer electrode 30a as an example. As illustrated in FIG. 8B, the first upper plating layer 36a included in the first outer electrode 30a includes an Ni plating layer 36al and an Sn plating layer 36a2. Preferably, the relationship between a thickness t4 of Sn plating disposed at a first recess 40a (or a second recess 42a) and a thickness t5 of Sn plating disposed at a center position (1/2), on the first surface 12a, of a distance l in the second direction z closer to the first surface 12a of the first outer electrode 30a is |t4−t5|≤t5/2, for example. Preferably, the relationship between the thickness of Sn plating disposed at the first recess 40a (or the second recess 42a) and a thickness t6 in an area that is located about 10 μm from the end of Sn plating disposed on the first surface 12a is |t4−t6|≤t6/2, for example.

Sn plating of the second upper plating layer 36b included in the second outer electrode 30b, Sn plating of the third upper plating layer 36c included in the third outer electrode 30c, and Sn plating of the fourth upper plating layer 36d included in the fourth outer electrode 30d also have the structure of Sn plating of the first upper plating layer 36a included in the first outer electrode 30a.

Preferably, the thickness of each upper plating layer 36 is, for example, greater than or equal to about 0.5 μm and less than or equal to about 10 μm, for example.

Preferably, the metal ratio per unit volume in the upper plating layer is higher than or equal to about 99 vol %, for example.

Preferably, the thickness of one layer in the upper plating layer is greater than or equal to about 0.5 μm and less than or equal to about 10.0 μm, for example.

The dimension, in the first direction y, of the multilayer ceramic capacitor 10 including the multilayer body 12 and the outer electrodes 30 is defined as an W dimension, the dimension, in the lamination direction x, of the multilayer ceramic capacitor 10 including the multilayer body 12 and the outer electrodes 30 is defined as a T dimension, and the dimension, in the second direction z, of the multilayer ceramic capacitor 10 including the multilayer body 12 and the outer electrodes 30 is defined as a L dimension.

Preferably, the multilayer ceramic capacitor 10 has a W dimension in the first direction y greater than or equal to about 0.2 mm and less than or equal to about 3.2 mm, a T dimension in the lamination direction x greater than or equal to about 0.04 mm and less than or equal to about 0.22 mm, and a L dimension in the second direction z greater than or equal to about 0.2 mm and less than or equal to about 3.2 mm, for example. Preferably, the multilayer ceramic capacitor 10 has dimensions satisfying about 0.85≤L/W≤about 1.00, for example. The multilayer body 12 with this structure has a substantially tetragonal shape, and is more freely mountable.

The multilayer ceramic capacitor 10 illustrated in FIG. 1 includes the first recesses 40 located at the inner side of the multilayer body 12. During mounting, these first recesses 40 can reduce solder wetting up from the first surface 12a to the outer electrodes disposed on the surface adjacent to the first surface 12a in the second direction z.

An example of a method for manufacturing the multilayer ceramic capacitor according to the first example embodiment of the present invention is described below.

A dielectric sheet and an electroconductive paste for the inner electrodes are prepared first. The dielectric sheet and the electroconductive paste for the inner electrodes include a binder and a solvent. A known binder and a known solvent may be used as the binder and the solvent.

A predetermined pattern is printed by, for example, inkjet printing, screen printing, or photogravure on the dielectric sheets with the electroconductive paste for inner electrodes. Thus, dielectric sheets on each of which the pattern of the first inner electrode is formed, and dielectric sheets on each of which the pattern of the second inner electrode is formed are prepared. Thereafter, the sheets on each of which the pattern of the first inner electrode is printed and the sheets each of which the pattern of the second inner electrode is printed are laminated to form a portion serving as the inner layer portion 18. For example, when a print pattern of the inner electrode is defined by photogravure, the design for photogravure is used as a shape pattern of the first inner electrode, and is also changed to a main structure corresponding to the shape pattern of the second inner electrode to respectively form intended inner electrodes.

When a print pattern of an inner electrode layer is defined by screen printing, the design of a mask for screen printing is used as a shape pattern of the first inner electrode, and is also changed to a main structure corresponding to the shape pattern of the second inner electrode to respectively form intended inner electrodes.

A predetermined number of dielectric sheets on each of which the pattern of the inner electrode is not printed are then laminated to form a portion serving as the first outer layer portion 20a located closer to the first surface 12a. Thereafter, a portion serving as the inner layer portion 18 prepared in the above manner is laminated, and on this portion serving as the inner layer portion 18, a predetermined number of dielectric sheets on each of which the pattern of the inner electrode is not printed are laminated to form a portion serving as the second outer layer portion 20b closer to the second surface 12b. A multilayer sheet is manufactured in this manner.

Subsequently, the multilayer sheet is pressed in the lamination direction by, for example, isostatic pressing to fabricate a multilayer block.

The multilayer block is then cut into multilayer chips of a predetermined size. At this time, the corner portions and the ridgeline portions of the multilayer chips may be rounded by, for example, barrel finishing.

Each cut multilayer chip is then sintered to be formed into a multilayer body 12. Although depending on the material of ceramics or the inner electrodes, the sintering temperature is preferably greater than or equal to about 900° C. and less than or equal to about 1400° C., for example.

At this time, the first extended electrode portions 24a of the first inner electrodes 16a and the third extended electrode portions 24c of the second inner electrodes 16b are exposed from the third surface 12c of the multilayer body 12. In addition, the second extended electrode portions 24b of the first inner electrodes 16a and the fourth extended electrode portions 24d of the second inner electrodes 16b are exposed from the fourth surface 12d of the multilayer body 12.

Subsequently, the outer electrodes 30 are formed at the multilayer body 12.

First, the base layers 32 are formed to cover the inner electrodes 16 exposed to the surfaces of the multilayer body 12. The base layers 32 include Cu plating, and defined by electrolytic plating or electroless plating. The multilayer body 12 that has undergone plating is subjected to thermal processing to evaporate residual moisture left in the plating film or at the interface between the multilayer body 12 and the base layers 32.

After the base layers 32 are formed, predetermined portions of the first surface 12a and the second surface 12b located closer to the third surface 12c or the sixth surface 12f undergo surface treatment such as plasma etching to form areas in which the first recesses 40 and the second recesses 42 are to be formed.

Subsequently, the multilayer bodies 12 on each of which the base layers 32 are formed are aligned on a worktable, and the thin film layers 34 are then formed on the first surfaces 12a by, for example, sputtering.

Thereafter, the upper plating layers 36 are formed on the base layers 32 and the thin film layers 34 disposed on the surfaces of the multilayer bodies 12. More specifically, on the base layers 32 and the thin film layers 34, Ni plating layers and Sn plating layers are formed into an upper plating layer 36. The plating processing may be either electrolytic plating or electroless plating. However, electroless plating involves preprocessing using, for example, a catalyst to improve the plating deposition speed, and complicates the processing. Thus, using electrolytic plating is normally preferable. Alternatively, after each upper plating layer is formed, for example, after a Ni plating layer is formed, a recess may be formed, and then an Sn plating layer may be formed.

The multilayer ceramic capacitor 10 according to the first example embodiment illustrated in FIG. 1 can be manufactured in the above manner.

An example of a multilayer ceramic capacitor 110 according to a second example embodiment of the present invention is described.

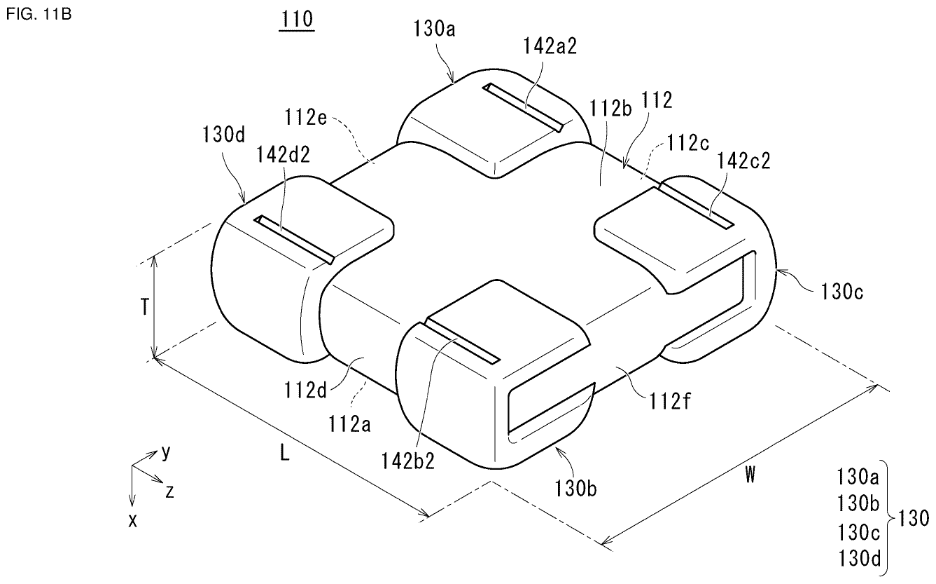

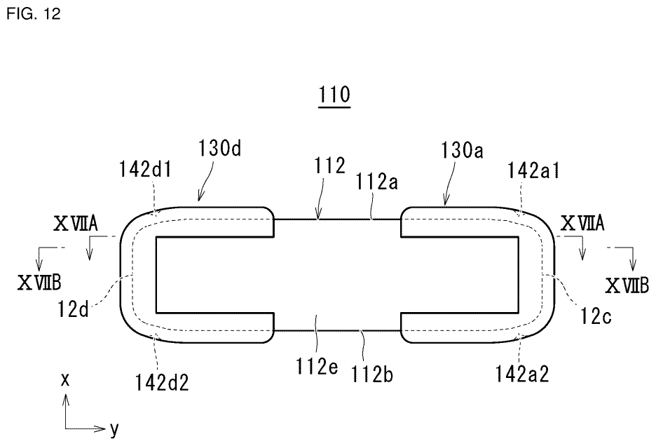

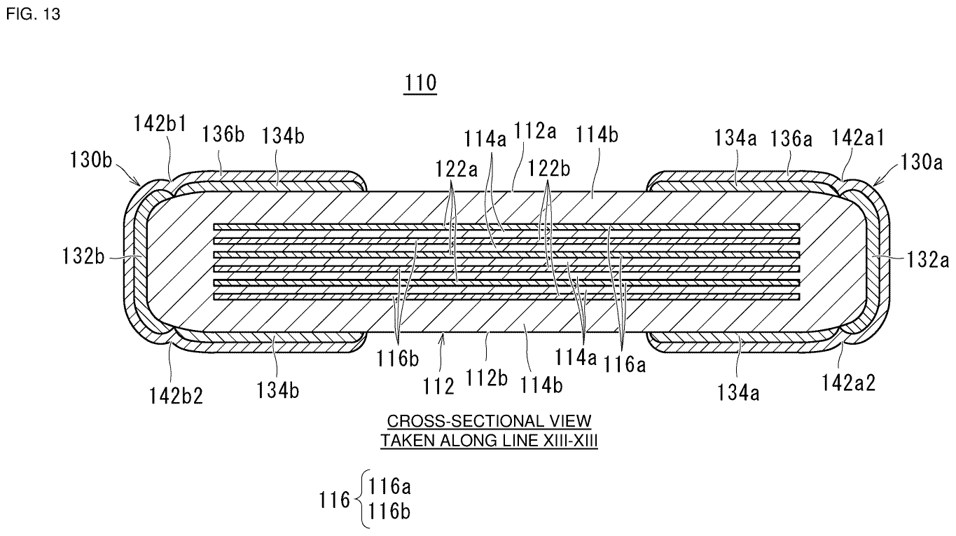

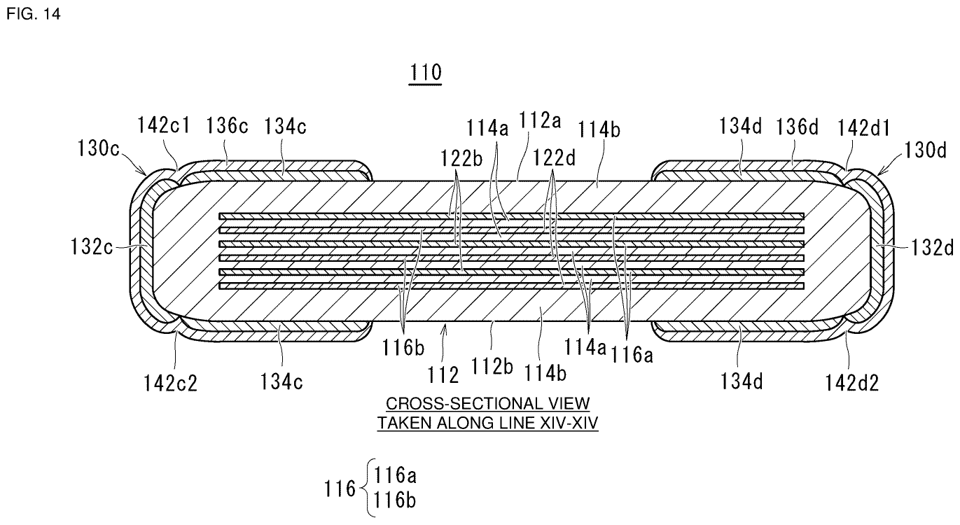

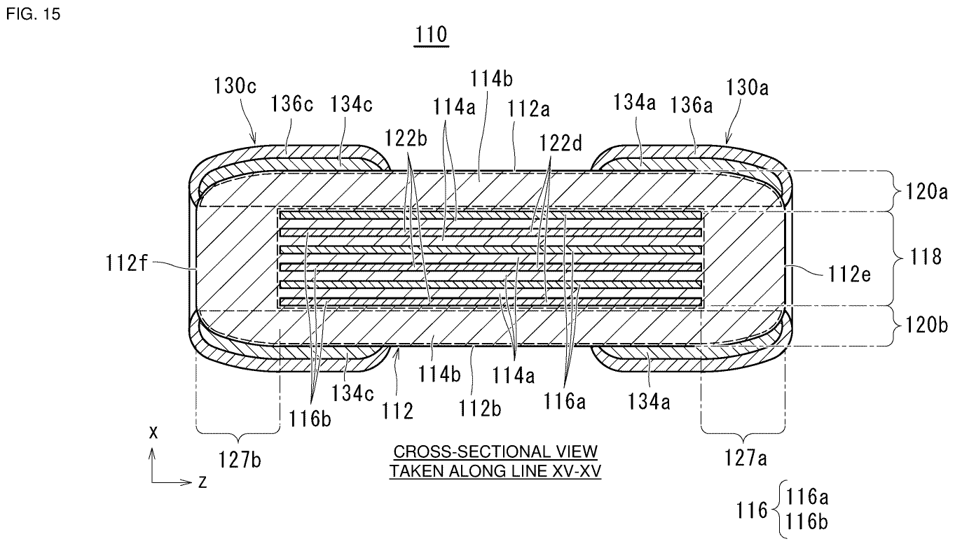

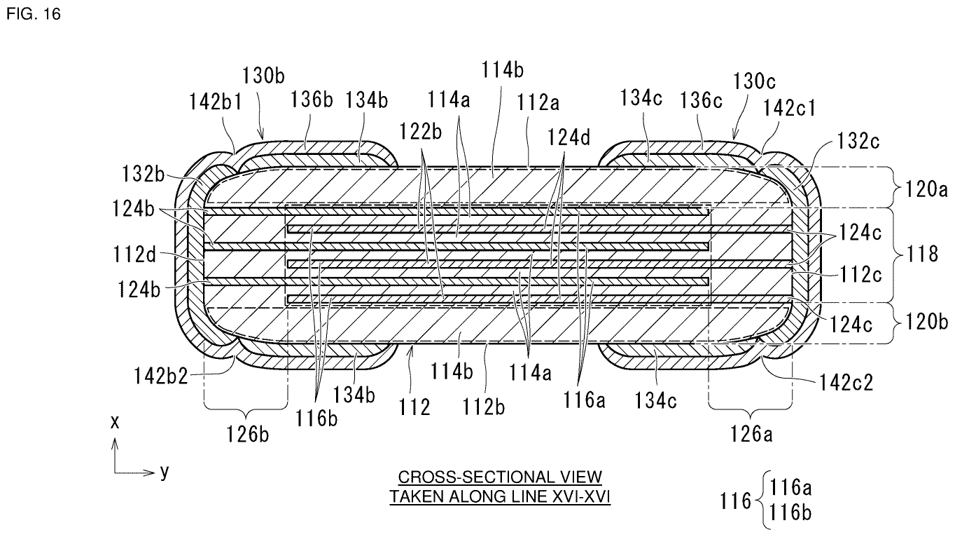

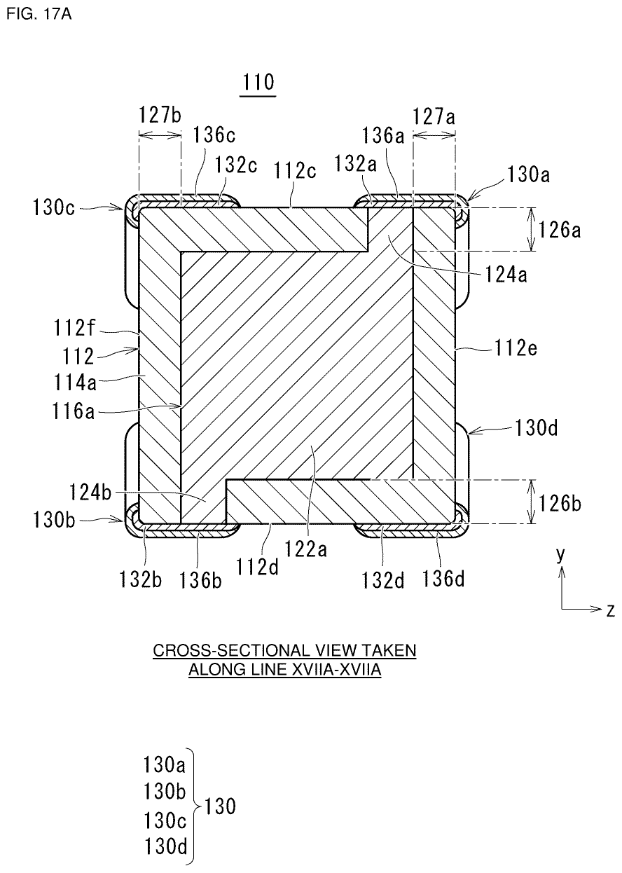

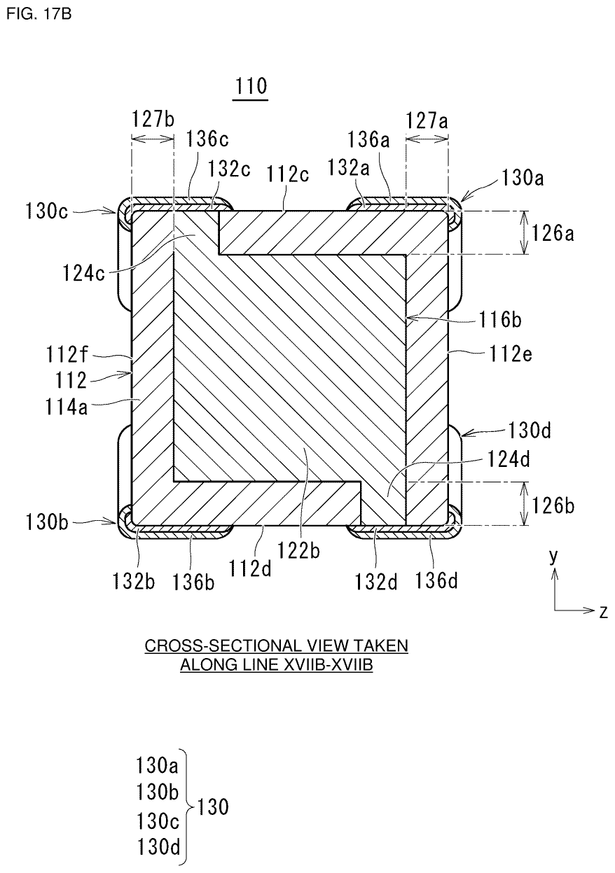

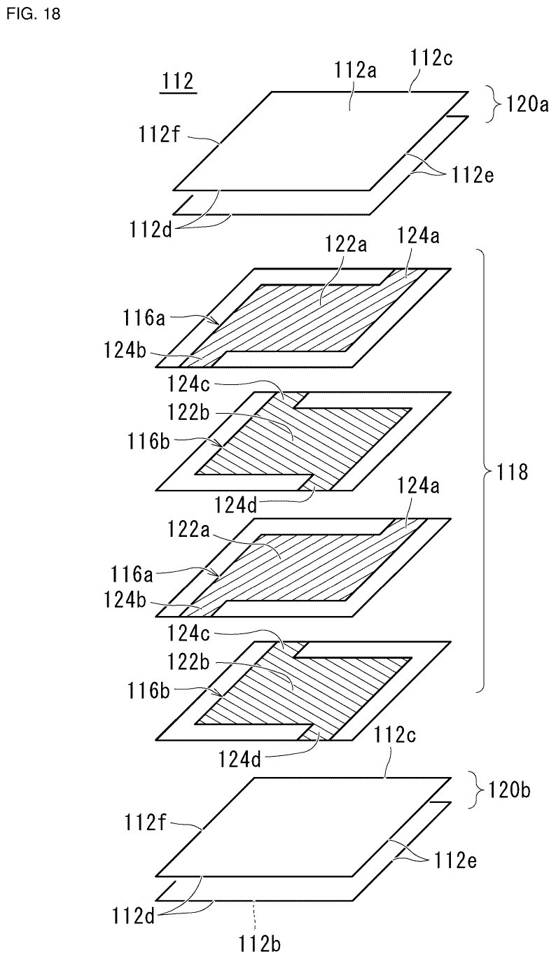

FIG. 11A is an external perspective view of the example of the multilayer ceramic capacitor according to the second example embodiment of the present invention, viewed in one direction. FIG. 11B is an external perspective view of the example of the multilayer ceramic capacitor according to the second example embodiment of the present invention, viewed in another direction. FIG. 12 is a front view of an example of the multilayer ceramic capacitor according to the second example embodiment of the present invention. FIG. 13 is a schematic cross-sectional view taken along line XIII-XIII in FIG. 11A. FIG. 14 is a schematic cross-sectional view taken along line XIV-XIV in FIG. 11A. FIG. 15 is a schematic cross-sectional view taken along line XV-XV in FIG. 11A. FIG. 16 is a schematic cross-sectional view taken along line XVI-XVI in FIG. 11A. FIG. 17A is a schematic cross-sectional view taken along line XVIIA-XVIIA in FIG. 12. FIG. 17B is a schematic cross-sectional view taken along line XVIIB-XVIIB in FIG. 12. FIG. 18 is an exploded perspective view of a multilayer body illustrated in FIG. 11A. Components the same as or corresponding to those illustrated in FIG. 1 to FIG. 7 are denoted by the same reference signs without being described in detail.

The multilayer ceramic capacitor 110 includes a multilayer body 112 and outer electrodes 130.

The multilayer body 12 includes multiple dielectric layers 114, and multiple inner electrodes 116. The dielectric layers 114 include inner dielectric layers 114a and outer dielectric layers 114b. The inner electrodes 116 include first inner electrodes 116a and second inner electrodes 116b.

The multilayer body 112 includes an inner layer portion 118, a first outer layer portion 120a located closer to a first surface 112a, and a second outer layer portion 120b located closer to a second surface 112b.

The first outer layer portion 120a is located closer to the first surface 112a of the multilayer body 112, and is a set of the multiple outer dielectric layers 114b located between the first surface 112a and the inner electrodes 116 located closest to the first surface 112a.

The second outer layer portion 120b is located closer to the second surface 112b of the multilayer body 12, and is a set of the multiple outer dielectric layers 114b located between the second surface 112b and the inner electrodes 116 located closest to the second surface 112b.

The area between the first outer layer portion 120a and the second outer layer portion 120b is the inner layer portion 118.

The inner layer portion 118 includes first inner electrodes 116a each including one end exposed to a third surface 112c and the other end exposed to a fourth surface 112d, second inner electrodes 116b each including one end exposed to the third surface 112c and the other end exposed to the fourth surface 112d, and inner dielectric layers 114a.

The dielectric layers 114 are the same as the dielectric layers 14 in, for example, the material, and thus are not described.

The inner electrodes 116 include multiple first inner electrodes 116a and multiple second inner electrodes 116b. The first inner electrodes 116a and the second inner electrodes 116b are alternately laminated with the dielectric layers 114 interposed therebetween.

The first inner electrodes 116a are disposed on the surfaces of the inner dielectric layers 114a. The first inner electrodes 116a each face the first surface 112a and the second surface 112b, each include a first opposite electrode portion 122a that faces the second inner electrodes 116b, and are laminated in a direction in which the first surface 112a and the second surface 112b are connected.

The first inner electrodes 116a are drawn out to the third surface 112c of the multilayer body 112 with first extended electrode portions 124a, and drawn out to the fourth surface 112d of the multilayer body 112 with second extended electrode portions 124b. The first extended electrode portions 124a are drawn to a portion of the multilayer body 112 closer to a fifth surface 112e, and the second extended electrode portions 124b are drawn to a portion of the multilayer body 12 closer to a sixth surface 112f.

The second inner electrodes 116b are disposed on surfaces of the inner dielectric layers 114a different from the inner dielectric layers 114a on which the first inner electrodes 116a are disposed. The second inner electrodes 116b each face the first surface 112a and the second surface 112b, each include a second opposite electrode portion 122b that faces the first inner electrodes 116a, and are laminated in a direction in which the first surface 112a and the second surface 112b are connected.

The second inner electrodes 116b are drawn out to the third surface 112c of the multilayer body 12 with third extended electrode portions 124c, and drawn out to the fourth surface 112d of the multilayer body 112 with fourth extended electrode portions 124d. The third extended electrode portions 124c are drawn to a portion of the multilayer body 112 closer to the sixth surface 112f, and the fourth extended electrode portions 124d are drawn to a portion of the multilayer body 112 closer to the fifth surface 112e.

The first inner electrodes 116a and the second inner electrodes 116b are not exposed to the fifth surface 112e and the sixth surface 112f of the multilayer body 112.

When the multilayer ceramic capacitor 110 is viewed in the lamination direction x, preferably, a straight line connecting the first extended electrode portion 124a and the second extended electrode portion 124b of each first inner electrode 116a and a straight line connecting the third extended electrode portion 124c and the fourth extended electrode portion 124d of each second inner electrode 116b cross each other.

Preferably, at the surfaces 112c and 112d of the multilayer body 112, the first extended electrode portions 124a of the first inner electrodes 116a and the fourth extended electrode portions 124d of the second inner electrodes 116b are drawn to opposite positions, and the second extended electrode portions 124b of the first inner electrodes 116a and the third extended electrode portions 124c of the second inner electrodes 116b are drawn to opposite positions.

As illustrated in FIG. 16, the multilayer body 112 includes a side portion (W gap) 126a of the multilayer body 112 located between the third surface 112c and the first end of the first opposite electrode portion 122a of each first inner electrode 116a in the first direction y, and a side portion (W gap) 126b of the multilayer body 112 located between the fourth surface 112d and the second end of the second opposite electrode portion 122b of each second inner electrode 116b in the first direction y.

As illustrated in FIG. 15, the multilayer body 112 further includes an end portion (L gap) 127a of the multilayer body 112 located between the fifth surface 112e and the first end of the second opposite electrode portion 122b of each second inner electrode 116b in the second direction z, and a end portion (L gap) 127b of the multilayer body 112 located between the sixth surface 112f and the second end of the first opposite electrode portion 122a of each first inner electrode 116a in the second direction z.

As illustrated in FIG. 11A to FIG. 16, the outer electrodes 130 are disposed at the multilayer body 12.

The outer electrodes 130 include multiple outer electrodes 130 connected to the first inner electrodes 116a and the second inner electrodes 116b. The outer electrodes 130 include a first outer electrode 130a, a second outer electrode 130b, a third outer electrode 130c, and a fourth outer electrode 130d.

The first outer electrode 130a is disposed on the third surface 112c to cover the first extended electrode portions 124a of the first inner electrodes 116a, and the first outer electrode 130a also covers a portion of the first surface 112a and a portion of the second surface 112b. The first outer electrode 130a is electrically connected to the first extended electrode portions 124a of the first inner electrodes 116a.

The second outer electrode 130b is disposed on the fourth surface 112d to cover the second extended electrode portions 124b of the first inner electrodes 116a, and the second outer electrode 130b also covers a portion of the first surface 112a and a portion of the second surface 112b. The second outer electrode 130b is electrically connected to the second extended electrode portions 124b of the first inner electrodes 116a.

The third outer electrode 130c is disposed on the third surface 112c to cover the third extended electrode portions 124c of the second inner electrodes 116b, and the third outer electrode 130c also covers a portion of the first surface 112a and a portion of the second surface 112b. The third outer electrode 130c is electrically connected to the third extended electrode portions 124c of the second inner electrodes 116b.

The fourth outer electrode 130d is disposed on the fourth surface 112d to cover the fourth extended electrode portions 124d of the second inner electrodes 116b, and the fourth outer electrode 130d also covers a portion of the first surface 112a and a portion of the second surface 112b. The fourth outer electrode 130d is electrically connected to the fourth extended electrode portions 124d of the second inner electrodes 116b.

As illustrated in FIG. 12, preferably, each outer electrode 130 disposed at the fifth surface 112e or the sixth surface 112f to which the inner electrodes 116 are not drawn has an angular C shape to cover a short side of any of the side surfaces to which the inner electrodes 116 are not drawn and portions from the end portions of the short side to middle portions of both long sides.

When viewed in the lamination direction x, each outer electrode 130 has a second recess 142 extending in the second direction z on the inner side of the multilayer body 112.

More specifically, when the first outer electrode 130a covers the first surface 112a, the second surface 112b, and the third surface 112c, when viewed in the lamination direction x from the first surface 112a, the first outer electrode 130a has a second recess 142a1 extending in the second direction z at a portion closer to the third surface 112c.

When the first outer electrode 130a covers the first surface 112a, the second surface 112b, and the third surface 112c, when viewed in the lamination direction x from the second surface 112b, the first outer electrode 130a has a second recess 142a2 extending in the second direction z at a portion closer to the third surface 112c.

When viewed in the lamination direction x from the first surface 112a, the dimension of the second recess 142a1 in the second direction z is, for example, greater than or equal to about 10% and less than or equal to about 96.0% of the dimension, in the second direction z, of the first outer electrode 130a in which the second recess 142a1 is formed. More preferably, the dimension of the second recess 142a1 in the second direction z is, for example, less than or equal to about 100% of the dimension of the first outer electrode 130a in the second direction z. Similarly, when viewed in the lamination direction x from the second surface 112b, the dimension of the second recess 142a2 in the second direction z is, for example, greater than or equal to about 10% and less than or equal to about 96.0% of the dimension, in the second direction z, of the first outer electrode 130a in which the second recess 142a2 is formed. More preferably, the dimension of the second recess 142a2 in the second direction z is, for example, less than or equal to about 100% of the dimension of the first outer electrode 130a in the second direction z. This structure can reduce solder excessively wetting up to the third surface 112c. When each of the second recess 142al and the second recess 142a2 is discontinuously formed, the dimension of the second recess 142al or the second recess 142a2 in the first direction y is defined by the total length of the second recess 142al or the second recess 142a2.

Preferably, the second recess 142al is located within a range greater than or equal to about 0.01 μm and less than or equal to about 10.0 μm from the outermost surface of the third surface 112c of the multilayer body 112, for example. Similarly, preferably, the second recess 142a2 is located within a range greater than or equal to about 0.01 μm and less than or equal to about 10.0 μm from the outermost surface of the third surface 112c of the multilayer body 112, for example. More specifically, the second recess 142al and the second recess 142a2 are located on the inner side of the multilayer body 112. This structure can block, using the second recess 142a1, or trap, in the second recess 142a1, solder wetting up from the first surface 112a to the outer electrode 130 on the surface adjacent to the first surface 112a in the second direction z, and thus can reduce solder wetting up to the third surface 112c.

When viewed in the second direction z, the distance from the bottom surface of the second recess 142al to the top of the upper plating layer 36, described later, located outward from the second recess 142al is preferably greater than or equal to about 1.0 μm, for example.

When the second outer electrode 130b covers the first surface 112a, the second surface 112b, and the fourth surface 112d, when viewed in the lamination direction x from the first surface 112a, the second outer electrode 130b has a second recess 142b1 extending in the second direction z at a portion closer to the fourth surface 112d.

When the second outer electrode 130b covers the first surface 112a, the second surface 112b, and the fourth surface 12d, when viewed in the lamination direction x from the second surface 112b, the second outer electrode 130b has a second recess 142b2 extending in the second direction z at a portion closer to the fourth surface 112d.

The second outer electrode 130b has the same structure as the first outer electrode 130a at other portions.

When the third outer electrode 130c covers the first surface 112a, the second surface 112b, and the third surface 112c, when viewed in the lamination direction x from the first surface 112a, the third outer electrode 130c has a second recess 142cl extending in the second direction z at a portion closer to the third surface 112c.

When the third outer electrode 130c covers the first surface 112a, the second surface 112b, and the third surface 112c, when viewed in the lamination direction x from the second surface 112b, the third outer electrode 130c has a second recess 142c2 extending in the second direction z at a portion closer to the third surface 112c.

The third outer electrode 130c has the same structure as the first outer electrode 130a at other portions.

When the fourth outer electrode 130d covers the first surface 112a, the second surface 112b, and the fourth surface 112d, when viewed in the lamination direction x from the first surface 112a, the fourth outer electrode 130d has a second recess 142d1 extending in the second direction z at a portion closer to the fourth surface 112d.

When the fourth outer electrode 130d covers the first surface 112a, the second surface 112b, and the fourth surface 112d, when viewed in the lamination direction x from the second surface 112b, the fourth outer electrode 130d has a second recess 142d2 extending in the second direction z at a portion closer to the fourth surface 112d.

The fourth outer electrode 130d has the same structure as the first outer electrode 130a at other portions.

In the multilayer body 112, the first opposite electrode portions 122a of the first inner electrodes 116a and the second opposite electrode portions 122b of the second inner electrodes 116b face one another with the inner dielectric layers 114a interposed therebetween to generate electrostatic capacitance. Thus, an electrostatic capacitance can be obtained between the first outer electrode 130a and the second outer electrode 130b to which the first inner electrodes 116a are connected and between the third outer electrode 130c and the fourth outer electrode 130d to which the second inner electrodes 116b are connected, and characteristics of a capacitor thus appear.

Preferably, the first outer electrode 130a, the second outer electrode 130b, the third outer electrode 130c, and the fourth outer electrode 130d each include a base layer 132, a thin film layer 134, and an upper plating layer 136.

The base layers 132 are disposed on the third surface 112c to the fourth surface 112d. Hereafter, a specific structure of the base layers 132 is described.

A first base layer 132a is disposed on the third surface 112c of the multilayer body 112 to cover the first extended electrode portions 124a of the first inner electrodes 116a exposed from the third surface 112c of the multilayer body 112.

A second base layer 132b is disposed on the fourth surface 112d of the multilayer body 112 to cover the second extended electrode portions 124b of the first inner electrodes 116a exposed from the fourth surface 112d of the multilayer body 112.

A third base layer 132c is disposed on the third surface 112c of the multilayer body 112 to cover the third extended electrode portions 124c of the second inner electrodes 116b exposed from the third surface 112c of the multilayer body 112.

A fourth base layer 132d is disposed on the fourth surface 112d of the multilayer body 112 to cover the fourth extended electrode portions 124d of the second inner electrodes 116b exposed from the fourth surface 112d of the multilayer body 112.

Preferably, the base layers 132 include Cu plating, although depending on the connectivity with the inner electrodes 116.

Preferably, the upper end of the first base layer 132a of the first outer electrode 130a is connected to a first thin film layer 134a on a ridgeline portion defined by the first surface 112a and the third surface 112c of the multilayer body 112. Preferably, the lower end of the first base layer 132a of the first outer electrode 130a is connected to the first thin film layer 134a on a ridgeline portion defined by the second surface 112b and the third surface 112c of the multilayer body 112.

As in the case of the first base layer 32a of the multilayer ceramic capacitor 10, also in the first base layer 132a of the multilayer ceramic capacitor 110, preferably, a distance in the lamination direction x between the end of the third surface 112c of the first base layer 132a in the lamination direction and the end portion of the inner electrode 116 located closest to the first surface 112a and exposed to the third surface 112c is greater than or equal to about 3.0 μm and less than or equal to about 8.1 μm, for example. Preferably, the first base layer 132a extends toward the first surface 112a. In other words, preferably, a distance in the lamination direction x from a point on the outermost surface of the first surface 112a located about 1.0 μm inward from the third surface 112c to the end of the first base layer 132a in the lamination direction x is less than or equal to about 10.0 μm, for example.

Preferably, a thickness of the first base layer 132a in the first direction y from the end portion of the inner electrode 116 located closest to the first surface 112a and exposed to the third surface 112c is greater than or equal to about 3.0 μm and less than or equal to about 8.1 μm, for example.

Preferably, the upper end of the second base layer 132b of the second outer electrode 130b is connected to a second thin film layer 134b on a ridgeline portion defined by the first surface 112a and the fourth surface 112d of the multilayer body 112. Preferably, the lower end of the second base layer 132b of the second outer electrode 130b is connected to the second thin film layer 134b on a ridgeline portion defined by the second surface 112b and the fourth surface 112d of the multilayer body 112.

The second outer electrode 130b has the same structure as the first outer electrode 130a at other portions.

Preferably, the upper end of the third base layer 132c of the third outer electrode 130c is connected to a third thin film layer 134c on a ridgeline portion defined by the first surface 112a and the third surface 112c of the multilayer body 112. Preferably, the lower end of the third base layer 132c of the third outer electrode 130c is connected to the third thin film layer 134c on a ridgeline portion defined by the second surface 112b and the third surface 112c of the multilayer body 112.

The third outer electrode 130c has the same structure as the first outer electrode 130a at other portions.

Preferably, the upper end of the fourth base layer 132d of the fourth outer electrode 130d is connected to a fourth thin film layer 134d on a ridgeline portion defined by the first surface 112a and the fourth surface 112d of the multilayer body 112. Preferably, the lower end of the fourth base layer 132d of the fourth outer electrode 130d is connected to the fourth thin film layer 134d on a ridgeline portion defined by the second surface 112b and the fourth surface 112d of the multilayer body 112. The fourth outer electrode 130d has the same structure as the first outer electrode 130a at other portions.

The thin film layers 134 include first thin film layers 134a, second thin film layers 134b, third thin film layers 134c, and fourth thin film layers 134d.

The first thin film layers 134a cover a portion of the first surface 112a and a portion of the second surface 112b of the multilayer body 112 at portions located closer to the third surface 112c and the fifth surface 112e. The first thin film layers 134a are preferably connected to the first base layer 132a.

The second thin film layers 134b cover a portion of the first surface 112a and a portion of the second surface 112b of the multilayer body 112 at portions located closer to the fourth surface 112d and the sixth surface 112f. The second thin film layers 134b are preferably connected to the second base layer 132b.

The third thin film layers 134c cover a portion of the first surface 112a and a portion of the second surface 112b of the multilayer body 112 at portions located closer to the third surface 112c and the sixth surface 112f. The third thin film layers 134c are preferably connected to the third base layer 132c.

The fourth thin film layers 134d cover a portion of the first surface 112a and a portion of the second surface 112b of the multilayer body 112 at portions located closer to the fourth surface 112d and the fifth surface 112e. The fourth thin film layers 134d are preferably connected to the fourth base layer 132d.

The upper plating layers 136 include a first upper plating layer 136a, a second upper plating layer 136b, a third upper plating layer 136c, and a fourth upper plating layer 136d.

The first upper plating layer 136a covers the first thin film layers 134a and the first base layer 132a disposed at the third surface 112c of the multilayer body 112.

The second upper plating layer 136b covers the second thin film layers 134b and the second base layer 132b disposed at the fourth surface 112d of the multilayer body 112.

The third upper plating layer 136c covers the third thin film layers 134c and the third base layer 132c disposed at the third surface 112c of the multilayer body 112.

The fourth upper plating layer 136d covers the fourth thin film layers 134d and the fourth base layer 132d disposed at the fourth surface 112d of the multilayer body 112.

Each upper plating layer 136 may include, for example, only Sn plating, or may preferably have a two-layer structure including Ni plating and Sn plating, or Ni plating and Cu plating.

Sn plating covers Ni plating. More specifically, Sn plating is defined by growing from Ni plating as a starting point. Preferably, Sn plating has a thickness greater than or equal to about 1.0 μm and less than or equal to about 5.0 μm, for example. The plating structure is described in detail using the first upper plating layer 136a of the first outer electrode 130a as an example.

As in the case of the upper plating layer 36 of the multilayer ceramic capacitor 10, also in the upper plating layer 136 of the multilayer ceramic capacitor 110, the first upper plating layer 136a included in the first outer electrode 130a includes an Ni plating layer and an Sn plating layer. Preferably, the relationship between a thickness t4 of Sn plating disposed at a second recess 142a and a thickness t5 of Sn plating disposed at a center position (1/2), on the first surface 112a, of a distance l in the second direction z closer to the first surface 112a of the first outer electrode 130a is |t4−t5|≤t5/2, for example. Preferably, the relationship between the thickness of Sn plating disposed at the second recess 142a and a thickness t6 in an area that is located about 10 μm from the end of Sn plating disposed on the first surface 112a is |t4−t6|≤t6/2, for example.

Sn plating of the second upper plating layer 136b included in the second outer electrode 130b, Sn plating of the third upper plating layer 136c included in the third outer electrode 130c, and Sn plating of the fourth upper plating layer 136d included in the fourth outer electrode 130d also have the structure of Sn plating of the first upper plating layer 136a included in the first outer electrode 130a.

The multilayer ceramic capacitor 110 illustrated in FIG. 11A has the same effects as the multilayer ceramic capacitor 10 according to the first example embodiment.

An example of a method for manufacturing a multilayer ceramic capacitor according to a second example embodiment is described below.

First, dielectric sheets and an electroconductive paste for an inner electrode are prepared. Dielectric sheets and an electroconductive paste for an inner electrode include a binder and a solvent. The binder and the solvent to be used may be a known binder and a known solvent.

Subsequently, a predetermined pattern is printed by, for example, inkjet printing, screen printing, or photogravure on the dielectric sheets with the electroconductive paste for inner electrodes. Thus, dielectric sheets each carrying the pattern of a first inner electrode and dielectric sheets each carrying the pattern of a second inner electrode are prepared. Thereafter, the sheets on each of which the pattern of a first inner electrode is printed and the sheets on each of which the pattern of a second inner electrode is printed are laminated to form a portion serving as the inner layer portion 18.

Thereafter, a predetermined number of dielectric sheets on each of which the pattern of the inner electrode is not printed are laminated to form a portion serving as the first outer layer portion 120a located closer to the first surface 112a. Thereafter, the prepared portion serving as the inner layer portion 118 is laminated, and on the portion serving as the inner layer portion 118, a predetermined number of dielectric sheets on each of which the pattern of the inner electrode is not printed are laminated to form a portion serving as the second outer layer portion 120b located closer to the second surface 112b. A multilayer sheet is manufactured in this manner.

Subsequently, the multilayer sheet is pressed in the lamination direction by a device such as an isostatic press to form a multilayer block.

The multilayer block is then cut into multilayer chips with a predetermined size. At this time, the corner portions and the ridgeline portions of the multilayer chips may be rounded by, for example, barrel finishing.

Each cut multilayer chip is then sintered to be formed into a multilayer body 112. Although depending on the material of ceramics or the inner electrodes, the sintering temperature is preferably greater than or equal to about 900° C. and less than or equal to about 1400° C., for example.

At this time, the first extended electrode portions 124a of the first inner electrodes 116a and the third extended electrode portions 124c of the second inner electrodes 116b are exposed from the third surface 112c of the multilayer body 112. The second extended electrode portions 124b of the first inner electrodes 116a and the fourth extended electrode portions 124d of the second inner electrodes 116b are also exposed from the fourth surface 112d of the multilayer body 112.

The outer electrodes 130 are then formed at the multilayer body 112.

First, each base layer 132 is formed to cover the inner electrodes 116 exposed to the surfaces of the multilayer body 112. Each base layer 132 is formed from Cu plating, and defined by electrolytic plating or electroless plating. The multilayer body 112 that has undergone plating is subjected to thermal processing to evaporate residual moisture left in the plating film or at the interface between the multilayer body 112 and the base layers 132.

After the base layer 132 is formed, predetermined portions of the first surface 112a and the second surface 112b located closer to the third surface 112c to the sixth surface 112f undergo surface treatment such as plasma etching to form areas in which the second recesses 142 are to be formed.

Subsequently, the multilayer bodies 112 on each of which the base layers 132 are formed are aligned on a worktable, and the thin film layers 134 are then formed on the first surfaces 112a and the second surface 112b by, for example, sputtering.

Thereafter, the upper plating layers 136 are formed on the surfaces of the thin film layers 134 and the multilayer bodies 112. More specifically, on the thin film layers 134, Ni plating layers and Sn plating layers are formed into an upper plating layer 136. The plating processing may be either electrolytic plating or electroless plating. However, electroless plating involves preprocessing using, for example, a catalyst to improve the plating deposition speed, and complicates the processing. Thus, using electrolytic plating is normally preferable. Alternatively, after each upper plating layer is formed, for example, after a Ni plating layer is formed, a recess may be formed, and then an Sn plating layer may be formed.

With the upper plating layer 136, each outer electrode 130 disposed at the side surface to which the inner electrodes 116 are not drawn has an angular C shape to cover both short sides of any of the side surfaces to which the inner electrodes 116 are not drawn and portions from the end portions of both short sides to middle portions of both long sides.

The multilayer ceramic capacitor 110 illustrated in FIG. 13 is manufactured in the above manner.

An example of a multilayer ceramic capacitor 210 according to a third example embodiment of the present invention is described.

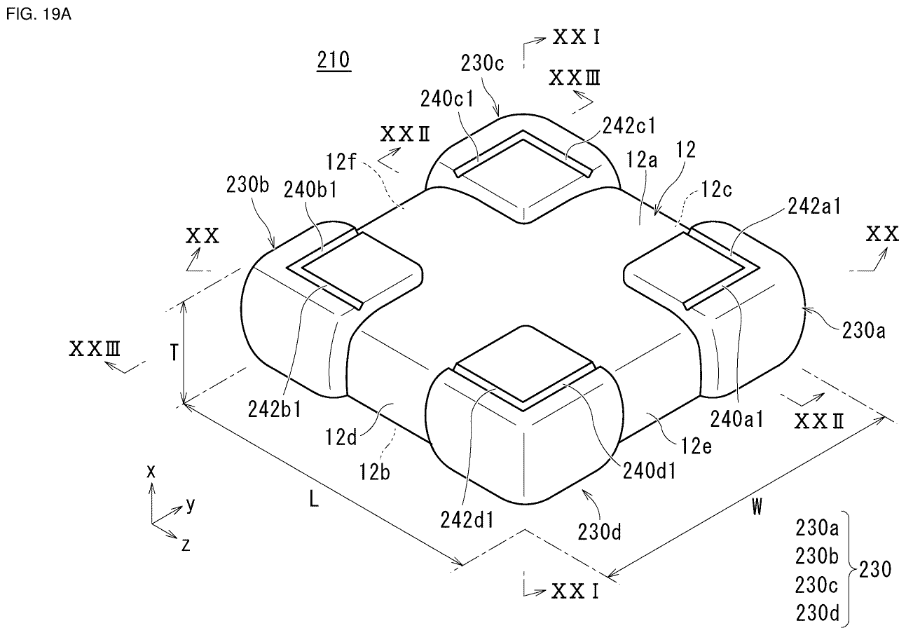

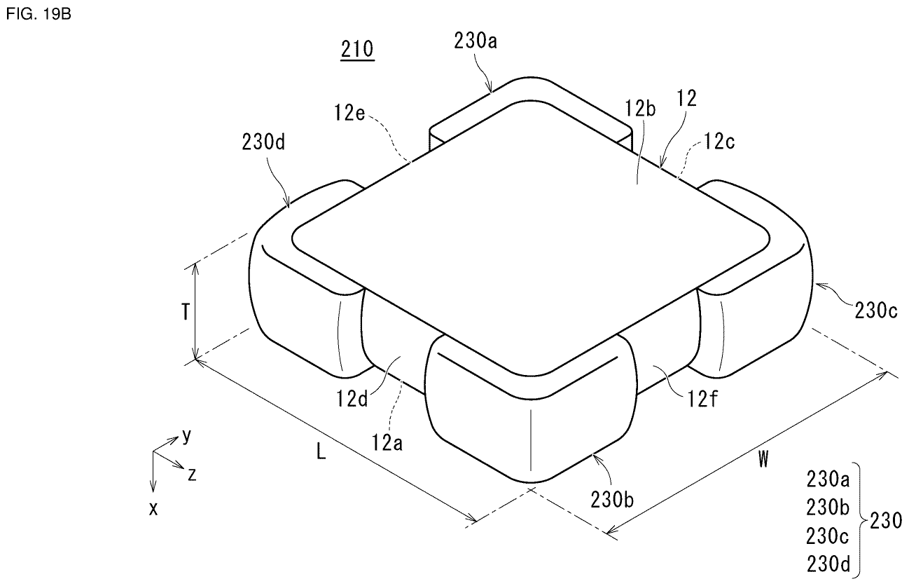

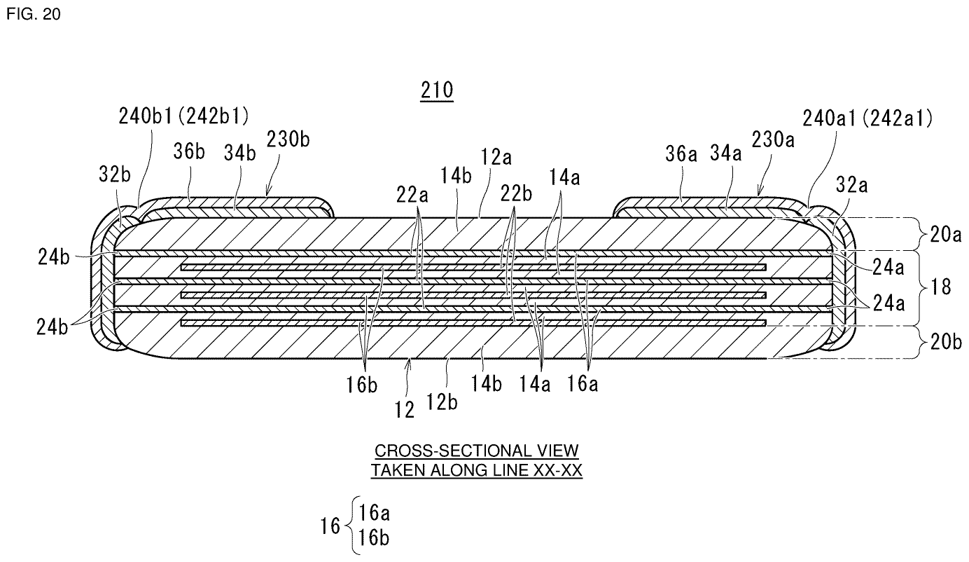

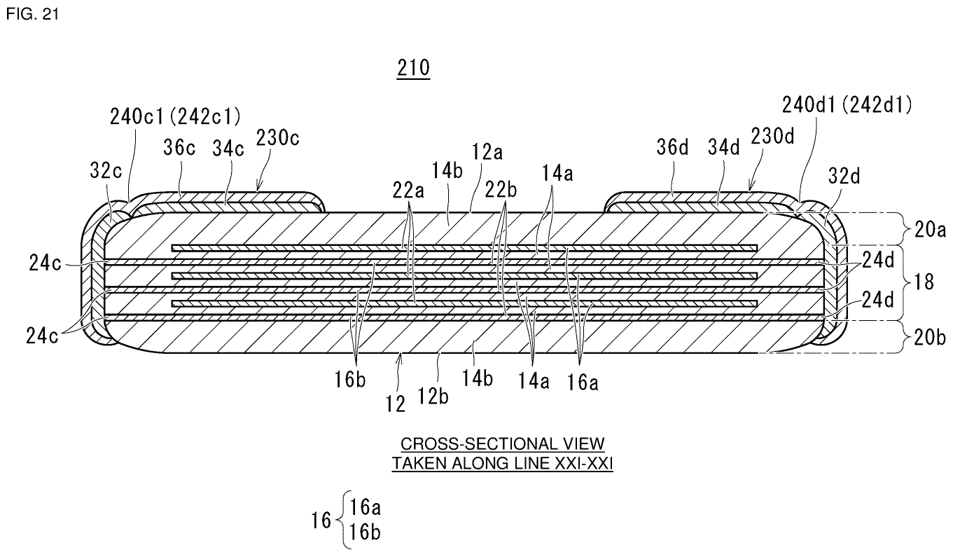

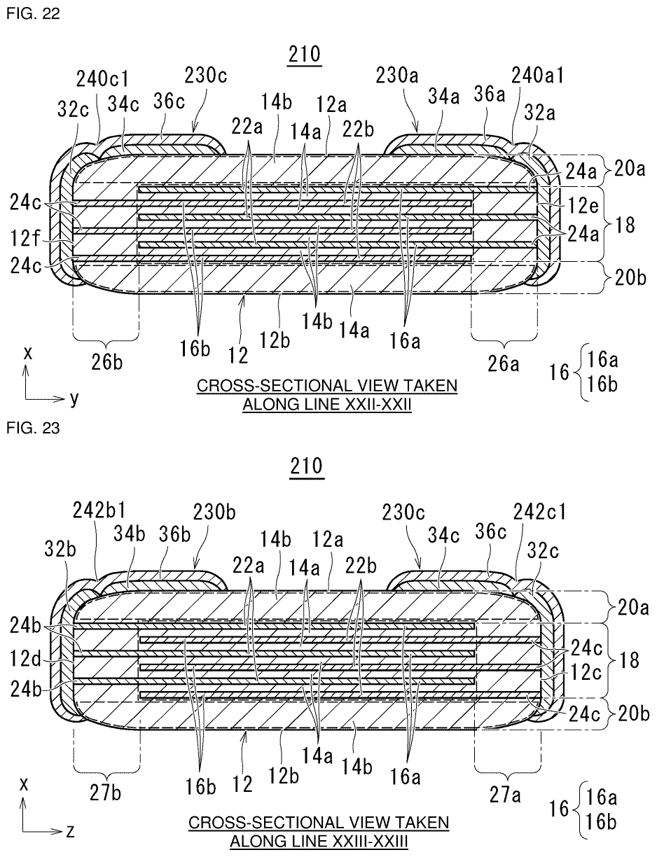

FIG. 19A is an external perspective view of an example of a multilayer ceramic capacitor according to a third example embodiment of the present invention. FIG. 19B is an external perspective view of the example of the multilayer ceramic capacitor according to the second example embodiment of the present invention, when viewed in another direction. FIG. 20 is a schematic cross-sectional view taken along line XX-XX in FIG. 19A. FIG. 21 is a schematic cross-sectional view taken along line XXI-XXI in FIG. 19A. FIG. 22 is a schematic cross-sectional view taken along line XXII-XXII in FIG. 19A. FIG. 23 is a schematic cross-sectional view taken along line XXIII-XXIII in FIG. 19A. Components the same as or corresponding to those illustrated in FIG. 1 to FIG. 7 are denoted by the same reference signs without being described in detail.

The multilayer ceramic capacitor 210 includes a multilayer body 12 and multiple outer electrodes 230.

In the multilayer ceramic capacitor 210 according to the third example embodiment, the multilayer body 12 has the same structure as the multilayer body 12 according to the first example embodiment of the present invention illustrated in FIG. 1.

The inner electrodes 16 include multiple first inner electrodes 16a and multiple second inner electrodes 16b. The first inner electrodes 16a and the second inner electrodes 16b are alternately laminated with the dielectric layers 14 interposed therebetween.

The first inner electrodes 16a are disposed on the surfaces of the inner dielectric layers 14a. The first inner electrodes 16a each face the first surface 12a and the second surface 12b, each include a first opposite electrode portion 22a that faces the second inner electrodes 16b, and are laminated in a direction in which the first surface 12a and the second surface 12b are connected.

The first inner electrodes 16a are drawn out to the third surface 12c and the fifth surface 12e of the multilayer body 12 with first extended electrode portions 24a, and drawn out to the fourth surface 12d and the sixth surface 12f of the multilayer body 12 with second extended electrode portions 24b.

The second inner electrodes 16b are disposed on surfaces of the inner dielectric layers 14a different from the inner dielectric layers 14a on which the first inner electrodes 16a are disposed. The second inner electrodes 16b each face the first surface 12a and the second surface 12b, each include a second opposite electrode portion 22b that faces the first inner electrodes 16a, and are laminated in a direction in which the first surface 12a and the second surface 12b are connected.

The second inner electrodes 16b are drawn to the third surface 12c and the sixth surface 12f of the multilayer body 12 with third extended electrode portions 24c, and drawn to the fourth surface 12d and the fifth surface 12e of the multilayer body 12 with fourth extended electrode portions 24d.

When the multilayer ceramic capacitor 210 is viewed in the lamination direction x, preferably, a straight line connecting the first extended electrode portion 24a and the second extended electrode portion 24b of each first inner electrode 16a and a straight line connecting the third extended electrode portion 24c and the fourth extended electrode portion 24d of each second inner electrode 16b cross each other.

Preferably, at the surfaces 12c, 12d, 12e, and 12f of the multilayer body 12, the first extended electrode portions 24a of the first inner electrodes 16a and the fourth extended electrode portions 24d of the second inner electrodes 16b are drawn to opposite positions, and the second extended electrode portions 24b of the first inner electrodes 16a and the third extended electrode portions 24c of the second inner electrodes 16b are drawn to opposite positions.

As illustrated in FIG. 22, the multilayer body 12 includes a side portion (W gap) 26a of the multilayer body 12 located between the fifth surface 12e and the first ends of the second opposite electrode portions 22b of the second inner electrodes 16b in the first direction y, and a side portion (W gap) 26b of the multilayer body 12 located between the sixth surface 12f and the second ends of the first opposite electrode portions 22a of the first inner electrodes 16a in the first direction y.

As illustrated in FIG. 23, the multilayer body 12 further includes an end portion (L gap) 27a of the multilayer body 12 located between the third surface 12c and the first ends of the first opposite electrode portions 22a of the first inner electrodes 16a in the second direction z, and a end portion (L gap) 127b of the multilayer body 12 located between the fourth surface 12e and the second end of the second opposite electrode portion 22b of the second inner electrodes 16b in the second direction z.

As illustrated in FIG. 19A to FIG. 23, the outer electrodes 230 are disposed at the multilayer body 12.

The outer electrodes 230 include multiple outer electrodes 230 connected to the first inner electrodes 16a and the second inner electrodes 16b. The outer electrodes 230 include a first outer electrode 230a, a second outer electrode 230b, a third outer electrode 230c, and a fourth outer electrode 230d.

The first outer electrode 230a covers the first extended electrode portions 24a of the first inner electrodes 16a on the third surface 12c and the fifth surface 12e, and the first outer electrode 230a also covers a portion of the first surface 12a. The first outer electrode 230a is electrically connected to the first extended electrode portions 24a of the first inner electrodes 16a.

The second outer electrode 230b covers the second extended electrode portions 24b of the first inner electrodes 16a on the fourth surface 12d and the sixth surface 12f, and the second outer electrode 230b also covers a portion of the first surface 12a. The second outer electrode 230b is electrically connected to the second extended electrode portions 24b of the first inner electrodes 16a.

The third outer electrode 230c covers the third extended electrode portions 24c of the second inner electrodes 16b on the third surface 12c and the sixth surface 12f, and the third outer electrode 230c also covers a portion of the first surface 12a. The third outer electrode 230c is electrically connected to the third extended electrode portions 24c of the second inner electrodes 16b.

The fourth outer electrode 230d covers the fourth extended electrode portions 24d of the second inner electrodes 16b on the fourth surface 12d and the fifth surface 12e, and the fourth outer electrode 230d also covers a portion of the first surface 12a. The fourth outer electrode 230d is electrically connected to the fourth extended electrode portions 24d of the second inner electrodes 16b.

When viewed in the lamination direction x, each outer electrode 230 has a first recess 240 extending in the first direction y on the inner side of the multilayer body 12. Each outer electrode 230 may have a second recess 242 extending in the second direction z on the inner side of the multilayer body 12.

More specifically, when the first outer electrode 230a covers the first surface 12a, the third surface 12c, and the fifth surface 12e, when viewed in the lamination direction x from the first surface 12a, the first outer electrode 230a has a second recess 242al extending in the second direction z at a portion closer to the third surface 12c, and a first recess 240al extending in the first direction y at a portion closer to the fifth surface 12e.

When viewed in the lamination direction x from the first surface 12a, the dimension of the first recess 240al in the first direction y is, for example, greater than or equal to about 10% and less than or equal to about 96.0% of the dimension, in the first direction y, of the first outer electrode 230a in which the first recess 240al is formed. More preferably, the dimension of the first recess 240al in the first direction y is, for example, less than or equal to about 100% of the dimension of the first outer electrode 230a in the first direction y. This structure can reduce solder excessively wetting up to the fifth surface 12e. When the first recess 240al is discontinuously formed, the dimension of the first recess 240al in the first direction y is defined by the total length of the first recess 240al.

Preferably, the first recess 240al is located within a range greater than or equal to about 0.01 μm and less than or equal to about 10.0 μm from the outermost surface of the fifth surface 12e of the multilayer body 12, for example. More specifically, the first recess 240al is located on the inner side of the multilayer body 12. This structure can block, using the first recess 240al, or trap, in the first recess 240al, solder wetting up from the first surface 12a to the outer electrode 230 on the surface adjacent to the first surface 12a in the second direction z, and thus can reduce solder wetting up to the fifth surface 12e.

The first recess 240al and the second recess 242al may be connected to each other. The first recess 240al and the second recess 242al connected to each other can also reduce solder wetting up to a portion where adjacent two surfaces cross. When viewed in the first direction y, the distance from the bottom surface of the first recess 240al to the top of the upper plating layer 36, described later, located outward from the first recess 240al is preferably greater than or equal to about 1.0 μm, for example.

When the second outer electrode 230b covers the first surface 12a, the fourth surface 12d, and the sixth surface 12f, when viewed in the lamination direction x from the first surface 12a, the second outer electrode 230b has a second recess 242b1 extending in the second direction z at a portion closer to the fourth surface 12d, and a first recess 240b1 extending in the first direction y at a portion closer to the sixth surface 12f.

The second outer electrode 230b has the same structure as the first outer electrode 230a at other portions.

When the third outer electrode 230c covers the first surface 12a, the third surface 12c, and the sixth surface 12f, when viewed in the lamination direction x from the first surface 12a, the third outer electrode 230c has a second recess 242cl extending in the second direction z on a portion closer to the third surface 12c and a first recess 240cl extending in the first direction y on a portion closer to the sixth surface 12f.

The third outer electrode 230c has the same structure as the first outer electrode 230a at other portions.

When the fourth outer electrode 230d covers the first surface 12a, the fourth surface 12d, and the fifth surface 12e, when viewed in the lamination direction x from the first surface 12a, the fourth outer electrode 230d has a second recess 242d1 extending in the second direction z on a portion closer to the fourth surface 12d, and a first recess 240d1 extending in the first direction y on a portion closer to the fifth surface 12e.

The fourth outer electrode 230d has the same structure as the first outer electrode 230a at other portions.

Preferably, the first outer electrode 230a, the second outer electrode 230b, the third outer electrode 230c, and the fourth outer electrode 230d each include a base layer 32, a thin film layer 34, and an upper plating layer 36.

The base layers 32 are disposed on the third surface 12c to the sixth surface 12f. Hereafter, a specific structure of the base layers 32 is described.

The first base layer 32a is disposed on the third surface 12c and the fifth surface 12e of the multilayer body 12 to cover the first extended electrode portions 24a of the first inner electrodes 16a exposed from the third surface 12c and the fifth surface 12e of the multilayer body 12.

The second base layer 32b is disposed on the fourth surface 12d and the sixth surface 12f of the multilayer body 12 to cover the second extended electrode portions 24b of the first inner electrodes 16a exposed from the fourth surface 12d and the sixth surface 12f of the multilayer body 12.

The third base layer 32c is disposed on the third surface 12c and the sixth surface 12f of the multilayer body 12 to cover the third extended electrode portions 24c of the second inner electrodes 16b exposed from the third surface 12c and the sixth surface 12f of the multilayer body 12.

The fourth base layer 32d is disposed on the fourth surface 12d and the fifth surface 12e of the multilayer body 12 to cover the fourth extended electrode portions 24d of the second inner electrodes 16b exposed from the fourth surface 12d and the fifth surface 12e of the multilayer body 12.

Preferably, each base layer 32 is formed from Cu plating, although depending on the connectivity with the inner electrodes 16.

Preferably, the upper end of the first base layer 32a of the first outer electrode 230a is connected to the first thin film layer 34a on a ridgeline portion defined by the first surface 12a and each of the third surface 12c and the fifth surface 12e of the multilayer body 12.

As in the case of the first base layer 32a of the multilayer ceramic capacitor 10, also in the first base layer 32a of the multilayer ceramic capacitor 210, preferably, the distance in the lamination direction x between the upper end of the third surface 12c of the first base layer 32a in the lamination direction and the end portion of the inner electrode 16 located closest to the first surface 12a and exposed to the third surface 12c is, for example, greater than or equal to about 3.0 μm and less than or equal to about 8.1 μm. Preferably, the first base layer 32a extends toward the first surface 12a. In other words, preferably, a distance in the lamination direction x from a point on the outermost surface of the first surface 12a located about 1.0 μm inward from the third surface 12c to the end of the first base layer 32a in the lamination direction x is less than or equal to about 10.0 μm, for example.

Preferably, a thickness of the first base layer 32a in the first direction y from the end portion of the inner electrode 16 located closest to the first surface 12a and exposed to the third surface 12c is, for example, greater than or equal to about 3.0 μm and less than or equal to about 8.1 μm.

Preferably, the upper end of the second base layer 32b of the second outer electrode 230b is connected to the second thin film layer 34b on a ridgeline portion defined by the first surface 12a and each of the fourth surface 12d, and the sixth surface 12f of the multilayer body 12.

The second outer electrode 230b has the same structure as the first outer electrode 230a at other portions.

Preferably, the upper end of the third base layer 32c of the third outer electrode 230c is connected to the third thin film layer 34c on a ridgeline portion defined by the first surface 12a and each of the third surface 12c and the sixth surface 12f of the multilayer body 12.

The third outer electrode 230c has the same structure as the first outer electrode 230a at other portions.

Preferably, the upper end of the fourth base layer 32d of the fourth outer electrode 230d is connected to the fourth thin film layer 34d on a ridgeline portion defined by the first surface 12a and each of the fourth surface 12d, and the fifth surface 12e of the multilayer body 12.

The fourth outer electrode 230d has the same structure as the first outer electrode 230a at other portions.

The thin film layers 34 include a first thin film layer 34a, a second thin film layer 34b, a third thin film layer 34c, and a fourth thin film layer 34d.

The first thin film layer 34a covers a portion of the first surface 12a of the multilayer body 12 located closer to the third surface 12c and the fifth surface 12e. The first thin film layer 34a is preferably connected to the first base layer 32a.

The second thin film layer 34b covers a portion of the first surface 12a of the multilayer body 12 located closer to the fourth surface 12d and the sixth surface 12f. The second thin film layer 34b is preferably connected to the second base layer 32b.

The third thin film layer 34c covers a portion of the first surface 12a of the multilayer body 12 located closer to the third surface 12c and the sixth surface 12f. The third thin film layer 34c is preferably connected to the third base layer 32c.

The fourth thin film layer 34d covers a portion of the first surface 12a of the multilayer body 12 located closer to the fourth surface 12d and the fifth surface 12e. The fourth thin film layer 34d is preferably connected to the fourth base layer 32d.

The upper plating layers 36 include a first upper plating layer 36a, a second upper plating layer 36b, a third upper plating layer 36c, and a fourth upper plating layer 36d.

The first upper plating layer 36a covers the first thin film layer 34a and the first base layer 32a disposed at the third surface 12c and the fifth surface 12e of the multilayer body 12.

The second upper plating layer 36b covers the second thin film layer 34b and the second base layer 32b disposed at the fourth surface 12d and the sixth surface 12f of the multilayer body 12.

The third upper plating layer 36c covers the third thin film layer 34c and the third base layer 32c disposed at the third surface 12c and the sixth surface 12f of the multilayer body 12.

The fourth upper plating layer 36d covers the fourth thin film layer 34d and the fourth base layer 32d disposed at the fourth surface 12d and the fifth surface 12e of the multilayer body 12.

Each upper plating layer 36 may include, for example, only Sn plating, or may preferably have a two-layer structure including Ni plating and Sn plating, or Ni plating and Cu plating.

Sn plating covers Ni plating. More specifically, Sn plating is defined by growing from Ni plating as a starting point. Preferably, Sn plating has a thickness greater than or equal to about 1.0 μm and less than or equal to about 5.0 μm, for example. The plating structure is described in detail using the first upper plating layer 36a of the first outer electrode 230a as an example. As in the case of the upper plating layer 36 of the multilayer ceramic capacitor 10, also in the upper plating layer 36 in the multilayer ceramic capacitor 210, the first upper plating layer 36a included in the first outer electrode 230a includes an Ni plating layer and an Sn plating layer. Preferably, the relationship between a thickness t4 of Sn plating disposed at a first recess 240a (or a second recess 242a) and a thickness t5 of Sn plating disposed at a center position (1/2), on the first surface 112a, of a distance l in the second direction z closer to the first surface 12a of the first outer electrode 230a is |t4−t5|≤t5/2, for example. Preferably, the relationship between the thickness of Sn plating disposed at the first recess 240a (or the second recess 242a) and a thickness t6 in an area that is located about 10 μm from the end of Sn plating disposed on the first surface 12a is |t4−t6|≤t6/2, for example.

Sn plating of the second upper plating layer 36b included in the second outer electrode 230b, Sn plating of the third upper plating layer 36c included in the third outer electrode 230c, and Sn plating of the fourth upper plating layer 36d included in the fourth outer electrode 230d also have the structure of Sn plating of the first upper plating layer 36a included in the first outer electrode 230a.

The multilayer ceramic capacitor 210 according to the third example embodiment illustrated in FIG. 19A has the same effects as the multilayer ceramic capacitor 10, and also has the effects described below.

As in the case of the multilayer ceramic capacitor 10 illustrated in FIG. 1, the multilayer ceramic capacitor 210 according to a third example embodiment illustrated in FIG. 19A in which each outer electrode 230 covers simply the first surface 12a of the multilayer body 12 without covering the second surface 12b also has reduced height without lowering the mounting performance.

The multilayer ceramic capacitor 210 according to the third example embodiment may be disposed to allow each outer electrode 230 to cover a portion of the second surface 12b without covering the first surface 12a.

An example of a method for manufacturing a multilayer ceramic capacitor according to the third example embodiment is described below.

First, dielectric sheets, an electroconductive paste for an inner electrode, and an electroconductive paste for surrounding electrodes are prepared. Dielectric sheets, an electroconductive paste for an inner electrode, and an electroconductive paste for surrounding electrodes include a binder and a solvent. The binder and the solvent to be used may be a known binder and a known solvent.

Subsequently, a predetermined pattern is printed by, for example, inkjet printing, screen printing, or photogravure on the dielectric sheets with the electroconductive paste for an inner electrode and the electroconductive paste for surrounding electrodes. Thus, dielectric sheets each carrying the pattern of a first inner electrode and the pattern of a first surrounding electrode and dielectric sheets each carrying the pattern of a second inner electrode and the pattern of a second surrounding electrode are prepared. Thereafter, the sheets on each of which the pattern of the first inner electrode and the pattern of the first surrounding electrode are printed and the sheets on each of which the pattern of the second inner electrode and the pattern of the second surrounding electrode are printed are laminated to form a portion serving as the inner layer portion 18.

During printing of the pattern using each electroconductive paste, first, the pattern is printed with an electroconductive paste for an inner electrode, and then the pattern is printed with an electroconductive paste for surrounding electrodes.

Thereafter, a predetermined number of dielectric sheets on each of which neither the pattern of the inner electrode nor the pattern of the surrounding electrodes is printed are laminated to form a portion serving as the first outer layer portion 20a located closer to the first surface 12a. Thereafter, the prepared portion serving as the inner layer portion 18 is laminated, and a predetermined number of dielectric sheets on each of which neither the pattern of the inner electrode nor the pattern of the surrounding electrodes is printed are laminated on the portion serving as the inner layer portion 18 to form a portion serving as the second outer layer portion 20b located closer to the second surface 12b. A multilayer sheet is manufactured in this manner.

Subsequently, the multilayer sheet is pressed in the lamination direction by a device such as an isostatic press to form a multilayer block.

The multilayer block is then cut into multilayer chips with a predetermined size. At this time, the corner portions and the ridgeline portions of the multilayer chips may be rounded by, for example, barrel finishing.

Each cut multilayer chip is then sintered to be formed into a multilayer body 12. Although depending on the material of ceramics or the inner electrodes, the sintering temperature is preferably greater than or equal to about 900° C. and less than or equal to about 1400° C., for example.

At this time, the first extended electrode portions 24a of the first inner electrodes 16a and the third extended electrode portions 24c of the second inner electrodes 16b are exposed from the third surface 12c of the multilayer body 12. The second extended electrode portions 24b of the first inner electrodes 16a and the fourth extended electrode portions 24d of the second inner electrodes 16b are exposed from the fourth surface 12d of the multilayer body 12.

Each outer electrodes 230 is then formed at the multilayer body 12.

First, each base layer 32 is formed to cover the inner electrodes 16 exposed to the surfaces of the multilayer body 12. Each base layer 32 is formed from Cu plating, and defined by electrolytic plating or electroless plating. The multilayer body 12 that has undergone plating is subjected to thermal processing to evaporate residual moisture left in the plating film or at the interface between the multilayer body 12 and the base layers 32.

After the base layers 32 are formed, predetermined portions of the first surface 12a located closer to the third surface 12c to the sixth surface 12f undergo surface treatment such as plasma etching to form areas in which the first recess 240 and the second recess 242 are to be formed.

Subsequently, the multilayer bodies 12 on each of which the base layers 32 are formed are aligned on a worktable, and the thin film layers 34 are then formed on the first surfaces 12a and the second surface 12b by, for example, sputtering.

Thereafter, the upper plating layers 36 are formed on the thin film layers 34 and the surfaces of the multilayer bodies 12. More specifically, on the thin film layers 34, Ni plating layers and Sn plating layers are formed into an upper plating layer 36. The plating processing may be either electrolytic plating or electroless plating. However, electroless plating involves preprocessing using, for example, a catalyst to improve the plating deposition speed, and complicates the processing. Thus, using electrolytic plating is normally preferable. Alternatively, after each upper plating layer is formed, for example, after a Ni plating layer is formed, a recess may be formed, and then an Sn plating layer may be formed.

The multilayer ceramic capacitor 210 according to the third example embodiment illustrated in FIG. 22 is manufactured in the above manner.

Subsequently, to check the effects of the above multilayer ceramic capacitors according to example embodiments of the present invention, multilayer ceramic capacitors were manufactured as test pieces for experiments with the above manufacturing method to evaluate solder mount.

With the manufacturing methods according to the above example embodiments, multilayer ceramic capacitors serving as test pieces numbered test piece No. 1 to test piece no. 15 were fabricated. Multilayer ceramic capacitors having no recess were also fabricated as known products.

Structure of Multilayer Ceramic Capacitor: Multilayer Ceramic Capacitors Illustrated in FIG. 15

Dimension (L) of Multilayer Ceramic Capacitor: 480 μm Dimension (W) of Multilayer Ceramic Capacitor: 480 μm

Dimension (T) of Multilayer Ceramic Capacitor: 60 μm

Ceramic Material: BaTiO₃

Material of Inner Electrodes: Ni

Structure of Outer Electrodes

Base Layer: Cu Plating

Thin Film Layer: Sputtering Film Including at Least One of Ni, Cr, or Cu

Upper Plating Layer: Two-Layer Structure Including Ni Plating Layer and Sn Plating Layer

Solder Mount Method: An appropriate amount of a solder paste was applied to a specified position on the substrate, and a multilayer ceramic capacitor serving as a test piece was mounted at the position. The substrate on which the multilayer ceramic capacitor was mounted was then heated to complete soldering. In the same manner, a known product having no recess was mounted on the substrate with solder.

Evaluation Method: After the solder mount, the height of the multilayer ceramic capacitor to the outermost surface with reference to the substrate surface was measured using, for example, a laser microscope. A known product having no recess also underwent similar measurement. The difference therebetween in amount of wetting solder was then evaluated. x in Table 2 indicates the rate of the length of each recess to the dimension of the outer electrode in the first direction y or the dimension of the outer electrode in the second direction z.

The evaluation results are indicated in Table 1 and Table 2.

Table 1 indicates a change, with respect to the change of the distance t1, of a difference between the amount of wetting solder on each test piece and the amount of wetting solder on a known product.

Table 2 indicates a change, with respect to the change of the rate of the length of each recess with respect to the dimension of the outer electrode in the first direction or the dimension of the outer electrode in the second direction, of a difference between the amount of wetting solder on each test piece and the amount of wetting solder on a known product.

TABLE 1

| TEST PIECE NUMBER | 1 | 2 | 3 | 4 | 5 | 6 | 7 | 8 |
|---|---|---|---|---|---|---|---|---|
| DIMENSION OF DISTANCE t1 | 1.0 | 2.0 | 3.0 | 3.5 | 7.5 | 8.0 | 8.1 | 9.0 |
| (μm) | | | | | | | | |
| DIFFERENCE IN AMOUNT OF | −1.4 | −1.9 | −4.1 | −4.3 | −5.1 | −4.9 | −4.2 | −3.4 |
| WETTING SOLDER BETWEEN | | | | | | | | |
| EACH TEST PIECE AND KNOWN | | | | | | | | |
| PRODUCT (μm) | | | | | | | | |

TABLE 2

| TEST PIECE NUMBER | 9 | 10 | 11 | 12 | 13 | 14 | 15 |
|---|---|---|---|---|---|---|---|
| RATE x OF LENGTH OF EACH | 5.0 | 7.5 | 9.0 | 10.0 | 20.5 | 75.0 | 96.0 |
| RECESS WITH RESPECT TO | | | | | | | |
| DIMENSION OF OUTER | | | | | | | |
| ELECTRODE IN FIRST | | | | | | | |
| DIRECTION OR SECOND | | | | | | | |
| DIRECTION (%) | | | | | | | |
| DIFFERENCE IN AMOUNT OF | −0.3 | −0.8 | −2.3 | −3.3 | −4.1 | −4.6 | −5.2 |
| WETTING SOLDER BETWEEN | | | | | | | |
| EACH TEST PIECE AND KNOWN | | | | | | | |
| PRODUCT (μm) | | | | | | | |

Table 1 indicates that in each of test piece No. 1 to test piece No. 8, the amount of wetting solder was reduced within the range of about 1.0≤t1≤about 9.0, for example. Particularly, in test piece No. 3 to test piece No. 7, the amount of wetting solder was notably reduced within the range of about 3.0≤t1≤about 8.1, for example.

Table 2 indicates that in each of the test pieces, the amount of wetting solder was reduced, and particularly, in each of test piece No. 12 to test piece No. 15, the amount of wetting solder was reduced more than in the other test pieces within the range of about 10.0≤x≤about 96.0, for example. The amount of wetting solder was also reduced within the range of x≤about 100, for example.

Although the example embodiments of the present invention are described as above, the present invention is not limited to the example embodiments.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor, comprising:
a multilayer body including:
a first surface and a second surface opposite in a lamination direction;
a third surface and a fourth surface opposite in a first perpendicular or substantially perpendicular to the lamination direction; and
a fifth surface and a sixth surface opposite in a second perpendicular or substantially perpendicular to the lamination direction and the first direction;
a first outer electrode on the first surface and the third surface;
a second outer electrode on the first surface and the fourth surface;
a third outer electrode on the first surface and the third surface; and
a fourth outer electrode on the first surface and the fourth surface; wherein
the multilayer body includes:
a first inner electrode; and
a second inner electrode;
the first outer electrode includes:
a first base layer connected to the first inner electrode;
a first thin film layer on the first surface; and
a first upper plating layer;
the first outer electrode includes a first recess located on an inner side of the multilayer body; and
the first recess has a dimension in the second direction longer than a dimension in the first direction.

2. The multilayer ceramic capacitor according to claim 1, wherein the dimension of the first recess in the first direction is greater than or equal to about 10% and less than or equal to about 100% of a dimension of the first outer electrode in the first direction.

3. The multilayer ceramic capacitor according to claim 1, wherein the first recess is provided discontinuously in the first direction.

4. The multilayer ceramic capacitor according to claim 1, wherein the first recess is provided continuously in the first direction.

5. The multilayer ceramic capacitor according to claim 1, wherein a distance in the lamination direction from an innermost end portion of the first base layer to an outermost surface of the first upper plating layer located outward from the innermost end portion of the first base layer is greater than or equal to about 3.0 μm and less than or equal to about 8.1 μm.

6. The multilayer ceramic capacitor according to claim 1, wherein the multilayer body includes rounded corner portions and rounded ridgeline portions.

7. The multilayer ceramic capacitor according to claim 1, wherein the first outer electrode includes a second recess.

8. The multilayer ceramic capacitor according to claim 1, wherein each of the second outer electrode, the third outer electrode, and the fourth outer electrode includes the first recess.

9. The multilayer ceramic capacitor according to claim 8, wherein each of the second outer electrode, the third outer electrode, and the fourth outer electrode includes a second recess.

10. The multilayer ceramic capacitor according to claim 1, wherein the dimension of the first recess in the first direction is greater than or equal to about 10% and less than or equal to about 96% of a dimension of the first outer electrode in the first direction.

11. The multilayer ceramic capacitor according to claim 1, wherein the first recess is located within a range greater than or equal to about 0.01 μm and less than or equal to about 10.0 μm from an outermost surface of the fifth surface.

12. The multilayer ceramic capacitor according to claim 7, wherein the first recess and the second recess are connected to each other.

13. The multilayer ceramic capacitor according to claim 9, wherein the first recess and the second recess are connected to each other.

14. The multilayer ceramic capacitor according to claim 1, wherein the multilayer ceramic capacitor has a dimension W in the first direction greater than or equal to about 0.2 mm and less than or equal to about 3.2 mm, a dimension T in the lamination direction greater than or equal to about 0.04 mm and less than or equal to about 0.22 mm, and a dimension L in the second direction greater than or equal to about 0.2 mm and less than or equal to about 3.2 mm.

15. The multilayer ceramic capacitor according to claim 14, wherein a relationship about 0.85≤L/W≤about 1.00 is satisfied.

16. The multilayer ceramic capacitor according to claim 1, wherein multilayer body has substantially tetragonal shape.

17. The multilayer ceramic capacitor according to claim 1, wherein the multilayer body includes first and second side gap portions.

18. The multilayer ceramic capacitor according to claim 1, wherein the multilayer body includes first and second end gap portions.

19. The multilayer ceramic capacitor according to claim 1, wherein each of the first, second, third, and fourth outer electrodes cover the first surface but not the second surface.

20. The multilayer ceramic capacitor according to claim 1, wherein each of the first, second, third, and fourth outer electrodes cover the second surface but not the first surface.
